(19) United States
(12) Patent Application Publication
(10) Pub. No.: US 2023/0043618 A1
(43) Pub. Date: Feb. 9, 2023

(54) COMPUTATION APPARATUS, NEURAL NETWORK SYSTEM,NEURON MODEL APPARATUS, COMPUTATION METHOD AND PROGRAM

(71) Applicant: NEC Corporation, Tokyo (JP)

(72) Inventor: Yusuke SAKEMI, Tokyo (JP)

(73) Assignee: NEC Corporation, Tokyo (JP)

(21) Appl. No.: 17/872,096

(22) Filed: Jul. 25, 2022

(30) Foreign Application Priority Data
Aug. 6, 2021 (JP) 2021-130005

(51) Int. Cl. G06N 3/04

(52) U.S. Cl. CPC G06N 3/049; G06N 3/0454

(57) ABSTRACT

A computation apparatus includes a spiking neuron model that: varies, for each of a plurality of time intervals, an index value of a signal output based on an input condition of a signal in the time interval; detects an occurrence timing of a prescribed event relating to the index value; and outputs a signal at a timing that is within a first time interval and that is in accordance with the occurrence timing of the prescribed event within a second time interval. The first time interval is included in the plurality of time intervals. The second time interval is included in the plurality of time intervals and is a time interval further in past than the first time interval.

This application is based upon and claims the benefit of priority from Japanese patent application No. 2021-130005, filed on Aug. 6, 2021, the disclosure of which is incorporated herein in its entirety by reference.

### TECHNICAL FIELD

The present disclosure relates to a computation apparatus, a neural network system, a neuron model apparatus, a computation method and a program.

### BACKGROUND ART

One type of neural network is a spiking neural network (SNN). For example, Japanese Unexamined Patent Application, First Publication No. 2018-136919 A (hereinafter Patent Document 1) describes a neuromorphic computing system in which a spiking neural network is implemented on a neuromorphic computing device.

In the spiking neural network, neuron models have internal states known as membrane potentials, and they output signals known as spikes based on the time evolution of the membrane potentials.

### SUMMARY

A spiking neural network should preferably be able to efficiently perform data processing.

An example object of the present disclosure is to provide a computation apparatus, a neural network system, a neuron model apparatus, a computation method and a program that can solve the above-mentioned problems.

According to a first example aspect of the present disclosure, a computation apparatus includes a spiking neuron model that: varies, for each of a plurality of time intervals, an index value of a signal output based on an input condition of a signal in the time interval; detects an occurrence timing of a prescribed event relating to the index value; and outputs a signal at a timing that is within a first time interval and that is in accordance with the occurrence timing of the prescribed event within a second time interval. The first time interval is included in the plurality of time intervals. The second time interval is included in the plurality of time intervals and is a time interval further in past than the first time interval.

According to a second example aspect of the present disclosure, a neural network system includes a spiking neural network body and learning means. The spiking neural network body includes a spiking neuron model that: varies, for each of a plurality of time intervals, an index value of a signal output based on an input condition of a signal in the time interval; detects an occurrence timing of a prescribed event relating to the index value; and outputs a signal at a timing that is within a first time interval and that is in accordance with the occurrence timing of the prescribed event within a second time interval. The first time interval is included in the plurality of time intervals. The second time interval is included in the plurality of time intervals and is a time interval further in past than the first time interval. The learning means learns a weighting coefficient for the signal.

According to a third example aspect of the present disclosure, a neuron model apparatus includes: index value calculation means for varying, for each of a plurality of time intervals, an index value of a signal output based on an input condition of a signal in the time interval; detection means for detecting an occurrence timing of a prescribed event relating to the index value; and signal output means for outputting a signal at a timing that is within a first time interval and that is in accordance with the occurrence timing of the prescribed event within a second time interval. The first time interval is included in the plurality of time intervals. The second time interval is included in the plurality of time intervals and is a time interval further in past than the first time interval.

According to a fourth example aspect of the present disclosure, a computation method includes: varying, for each of a plurality of time intervals, an index value of a signal output based on an input condition of a signal in the time interval; detecting an occurrence timing of a prescribed event relating to the index value; and outputting a signal at a timing that is within a first time interval and that is in accordance with the occurrence timing of the prescribed event within a second time interval. The first time interval is included in the plurality of time intervals. The second time interval is included in the plurality of time intervals and is a time interval further in past than the first time interval.

According to a fifth example aspect of the present disclosure, a non-transitory recording medium stores a program that causes a programmable apparatus to execute: varying, for each of a plurality of time intervals, an index value of a signal output based on an input condition of a signal in the time interval; detecting an occurrence timing of a prescribed event relating to the index value; and outputting a signal at a timing that is within a first time interval and that is in accordance with the occurrence timing of the prescribed event within a second time interval, the first time interval being included in the plurality of time intervals, the second time interval being included in the plurality of time intervals and being a time interval further in past than the first time interval.

According to the present disclosure, a spiking neural network can efficiently perform data processing.

### BRIEF DESCRIPTION OF THE DRAWINGS

FIG. 1 is a diagram illustrating an example of the structure of a neural network apparatus according to an example embodiment.

FIG. 2 is a diagram illustrating an example of the structure of a spiking neural network provided in the neural network apparatus according to the example embodiment.

FIG. 3 is a diagram illustrating an example of the time variation in the membrane potential in a spiking neuron model in which the output timings of spike signals are not restricted.

FIG. 4 is a diagram illustrating an example of the output timings of spike signals from spiking neuron models in a spiking neural network in the case in which the output timings of the spike signals from the spiking neuron models are not restricted.

FIG. 5 is a diagram illustrating an example of data processing timings for each layer in the neural network apparatus according to the example embodiment.

FIG. 6 is a diagram illustrating a first example of a more specific structure of the neural network apparatus according to the example embodiment.

FIG. 7 is a diagram illustrating an example of the structures of a switching unit and a combining unit according to the example embodiment.

FIG. 8 is a diagram illustrating an example of spike signal transfer timings between neuron models in a neural network apparatus according to the example embodiment.

FIG. 9 is a diagram illustrating an example of the structures of sublayers in a neural network apparatus according to the example embodiment.

FIG. 10 is a diagram illustrating an example of data processing timings in the neural network apparatus according to the example embodiment.

FIG. 11 is a diagram illustrating a first example of a clip function according to the example embodiment.

FIG. 12 is a diagram illustrating a second example of the clip function according to the example embodiment.

FIG. 13 is a diagram illustrating a first example of a function indicating the timing when an i-th neuron model in an l-th layer according to the example embodiment processes d-th data.

FIG. 14 is a diagram illustrating a second example of a function indicating the timing when an i-th neuron model in an l-th layer according to the example embodiment processes d-th data.

FIG. 15 is a diagram illustrating a third example of a function indicating the timing when an i-th neuron model in an l-th layer according to the example embodiment processes d-th data.

FIG. 16 is a diagram illustrating a second example of a more specific structure of a computation apparatus according to the example embodiment.

FIG. 17 is a diagram illustrating an example of a system structure according to an example embodiment when learning.

FIG. 18 is a diagram illustrating an example of input and output of signals in a neural network system according to the example embodiment.

FIG. 19 is a diagram illustrating an example of input and output of signals in the neural network apparatus according to the example embodiment when operating.

FIG. 20 is a diagram illustrating an example of the structure of a computation apparatus according to the example embodiment.

FIG. 21 is a diagram illustrating an example of the structure of the neural network system according to the example embodiment.

FIG. 22 is a diagram illustrating an example of the structure of a neuron model apparatus according to the example embodiment.

FIG. 23 is a flow chart indicating an example of the processing sequence in a computation method according to the example embodiment.

FIG. 24 is a schematic block diagram illustrating the structure of a computer according to at least one example embodiment.

### EXAMPLE EMBODIMENT

Hereinafter, example embodiments of the present disclosure will be explained. However, the example embodiments below should not be construed as limiting the disclosure according to the claims. Additionally, not all combinations of the characteristics explained in the example embodiments are necessarily essential for the solution provided by the disclosure.

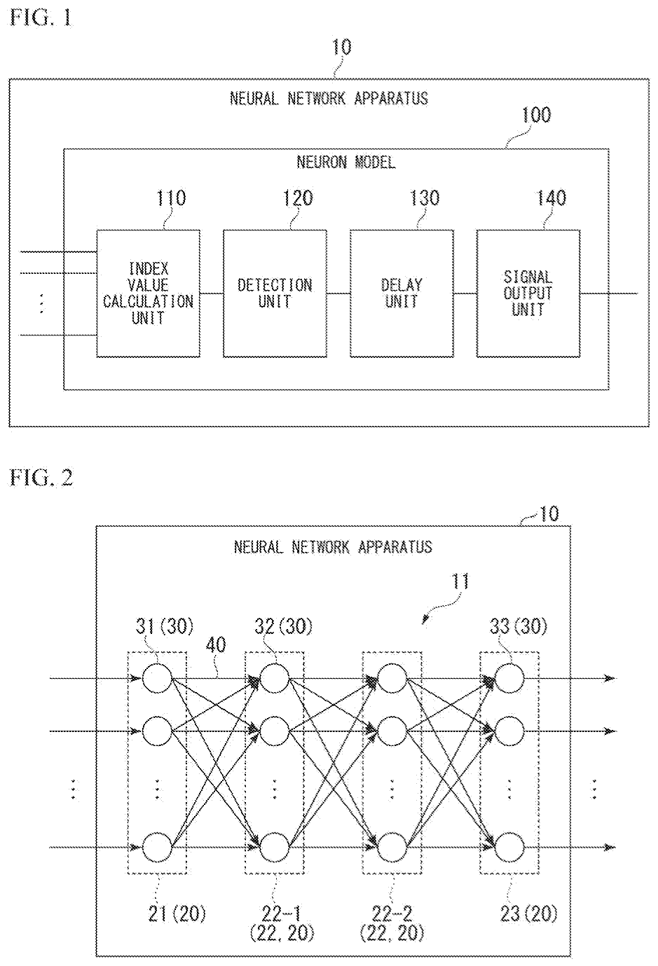

FIG. 1 is a diagram illustrating an example of the structure of a neural network apparatus according to an example embodiment. In the structure illustrated in FIG. 1, a neural network apparatus 10 includes a neuron model 100. The neuron model 100 includes an index value calculation unit 110, a detection unit 120, a delay unit 130 and a signal output unit 140.

The neural network apparatus 10 performs data processing by using a spiking neural network. Data processing will also be referred to as computation. The neural network apparatus 10 is an example of a computation apparatus.

The neural network apparatus mentioned here is an apparatus on which a neural network is implemented. A spiking neural network may be implemented in the neural network apparatus 10 by using hardware dedicated thereto. For example, a spiking neural network may be implemented on the neural network apparatus 10 by using an ASIC (Application-Specific Integrated Circuit) or an FPGA (Field-Programmable Gate Array). Alternatively, the spiking neural network may be implemented on the neural network apparatus 10 by software using a computer or the like.

An apparatus including an ASIC, an apparatus including an FPGA and a computer are all examples of a programmable apparatus. With an ASIC or an FPGA, an example of programming is to use a hardware description language to describe hardware, and to realize the described hardware on the ASIC or the FPGA. In the case in which the neural network apparatus 10 is formed by using a computer, the functions of a spiking neural network may be described by programming, and the resulting program may be executed on the computer.

The spiking neural network mentioned here is a neural network in which neuron models output signals at timings that are based on state amounts known as membrane potentials, which undergo time variations in accordance with input conditions of signals to the neuron models themselves. The membrane potentials will also be referred to as signal output index values, or simply as index values.

The time variations mentioned here refer to variations over time.

The neuron models in the spiking neural network will also be referred to as spiking neuron models. The signals output by the spiking neuron models will also be referred to as spike signals or as spikes. In the spiking neural network, binary signals can be used as the spike signals, and information may be transmitted between spiking neuron models by the transmission timings of spike signals, by the number of spike signals or the like.

In the case of a neuron model 100, the index value calculation unit 110 calculates membrane potentials based on the input conditions of spike signals to the neuron model 100. The signal output unit 140 outputs spike signals at timings in accordance with the time variation in the membrane potentials.

The spike signals used in the neural network apparatus 10 may be, but are not limited to being, pulse signals or step signals.

Hereinafter, a time-based scheme in which information is transmitted by means of the transmission timings of spike signals will be used as the scheme for transmitting information between the neuron models 100 in the spiking neural network by means of the neural network apparatus 10.

The processing performed by the neural network apparatus 10 may be various processes that can be executed by using the spiking neural network. For example, the neural network apparatus 10 may perform, but is not limited to performing, image recognition, biometric authentication or numerical prediction.

The neural network apparatus 10 may be formed as a single apparatus, or may be formed by combining multiple apparatuses. For example, each neuron model 100 may be formed as an apparatus, and the apparatuses formed from these individual neuron models 100 may be connected by signal transmission paths to form the spiking neural network.

FIG. 2 is a diagram illustrating an example of the structure of a spiking neural network provided in the neural network apparatus 10. The spiking neural network provided in the neural network apparatus 10 will also be described as a neural network 11. Additionally, the neural network 11 will also be referred to as a neural network body.

In the example in FIG. 2, the neural network 11 is formed as a feedforward four-layer spiking neural network. Specifically, the neural network 11 includes an input layer 21, two intermediate layers 22-1 and 22-2, and an output layer 23. The two intermediate layers 22-1 and 22-2 will also be described collectively as intermediate layers 22. The intermediate layers will also be referred to as hidden layers. The input layer 21, the intermediate layers 22 and the output layer 23 will also be described collectively as layers 20.

The input layer 21 includes input nodes 31. The intermediate layers 22 include intermediate nodes 32. The output layer 23 includes output nodes 33. The input nodes 31, the intermediate nodes 32 and the output nodes 33 will also be described collectively as nodes 30.

The input nodes 31, for example, convert input data to the neural network 11 into spike signals. Alternatively, in the case in which the input data to the neural network 11 is indicated by spike signals, the neuron models 100 may be used as the input nodes 31.

Neuron models 100 may be used for both the intermediate nodes 32 and the output nodes 33. Additionally, the operations of the neuron models 100 may differ between the intermediate nodes 32 and the output nodes 33, such as the constraint conditions placed on the signal output timings, to be described below, being more relaxed for the output nodes 33 than for the intermediate nodes 32.

The four layers 20 of the neural network 11 are arranged, from the upstream side in terms of signal transmission, in the order of the input layer 21, the intermediate layer 22-1, the intermediate layer 22-2 and the output layer 23. Between two adjacent layers 20, the nodes 30 are connected by transmission paths 40. The transmission paths 40 transmit spike signals from the nodes 30 of an upstream-side layer 20 to the nodes 30 of a downstream-side layer 20.

However, in the case in which the neural network 11 is formed as a feedforward spiking neural network, the number of layers is not limited to four, and there simply need to be two or more layers. Additionally, the number of neuron models 100 provided in each layer is not limited to a specific number, and each layer simply needs to be provided with one or more neuron models 100. Each layer may be provided with the same number of neuron models 100, or a different number of neuron models 100 may be provided depending on the layer. Additionally, the transmission destinations of the spike signals from each layer are not limited to being the next layer. The output from a certain layer may skip over an arbitrary number of layers and be transmitted to a later-stage layer.

Additionally, the neural network 11 may be, but is not limited to being, configured as a fully connected type. In the example in FIG. 2, all of the neuron models 100 in an earlier-stage layer 20 of mutually adjacent layers may be connected, by transmission paths 40, to all of the neuron models 100 in the later-stage layer 20. However, there may be cases in which some of neuron models 100 in mutually adjacent layers are not connected by transmission paths 40.

Hereinafter, the disclosure will be described under the assumption that the delay time for transmission of the spike signals can be ignored, so that the spike signal output times from the neuron models 100 on the spike signal output side are the same as the spike signal input times at the neuron models 100 on the spike signal input side. If the delay time for transmission of the spike signals cannot be ignored, then times obtained by adding the delay time to the spike signal output times may be used as the spike signal input times.

In a general spiking neuron model, the output timings of spike signals are not restricted, and spike signals are output at timings at which time-varying membrane potentials attain (reach) threshold values. In a spiking neural network based on spiking neuron models in which the output timings of spike signals are not restricted, if there are multiple items of data to be processed, then there is a need to wait until the spiking neural network has received inputs of input data and output computation results before the next input data can be input to the spiking neural network.

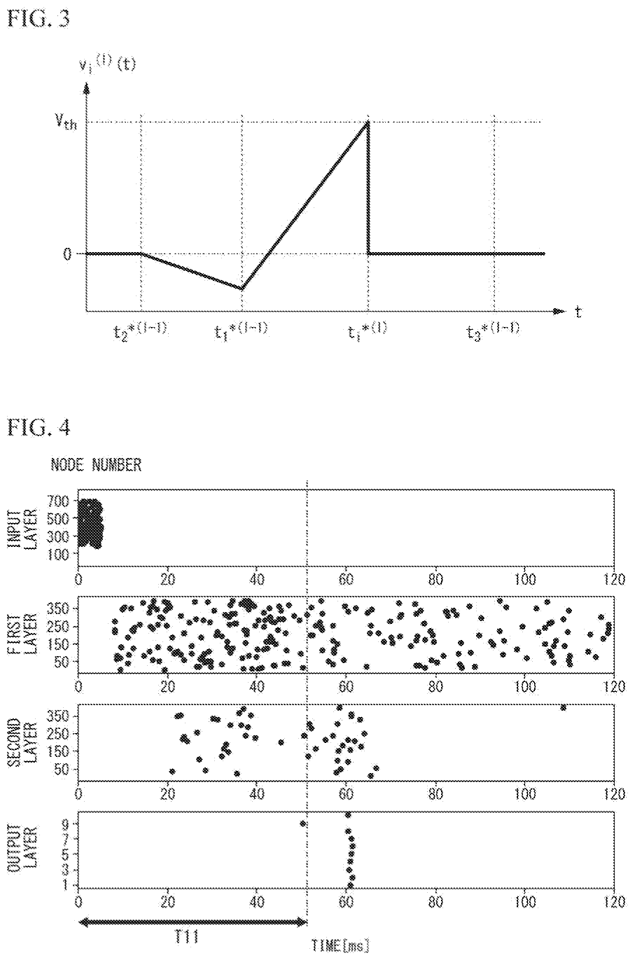

FIG. 3 is a diagram illustrating an example of the time variation in the membrane potential in a spiking neuron model in which the output timings of spike signals are not restricted. The horizontal axis in the graph in FIG. 3 represents the time. The vertical axis represents the membrane potential.

FIG. 3 illustrates an example of the membrane potential of the spiking neuron model that is the i-th node in the l-th layer. The membrane potential in the spiking neuron model that is the i-th node in the l-th layer at the time t is represented by vᵢ^{(l)}(t). In the explanation of FIG. 3, the spiking neuron model in the i-th node of the l-th layer will also be referred to as the target model.

In the example in FIG. 3, the target model receives inputs of spike signals from three spiking neuron models.

The time t₂^{*(l-1)} represents the input time of a spike signal from the second spiking neuron model in the (l−1)-th layer. The time t₁^{*(l-1)} represents the input time of a spike signal from the first spiking neuron model in the (l−1)-th layer. The time t₃^{*(l-1)} represents the input time of a spike signal from the third spiking neuron model in the (l−1)-th layer.

Additionally, the target model outputs a spike signal at the time tᵢ^{*(l)}. The spiking neuron model outputting a spike signal is referred to as firing. The time at which a spiking neuron model fires is referred to as the firing time.

In the example in FIG. 3, the initial value of the membrane potential is 0. The initial value of the membrane potential corresponds to the resting membrane potential.

Before the target model fires, after a spike signal is input, the membrane potential vᵢ^{(l)}(t) of the target model continuously varies at a variation rate (variation speed) in accordance with a weighting set for each spike signal transmission path. Additionally, the variation rate of the membrane potential for each spike signal input is added linearly. The equation for the derivative of the membrane potential vᵢ^{(l)}(t) in the example in FIG. 3 is represented by Expression (1).

$$( Expression ( 1 ) )$$

$$\frac{d}{d t} {v}_{i}^{( l )} ( t ) = {\sum }_{j} {w}_{i j}^{( l )} θ ( t - {t}_{j}^{* ( l - 1 )} ) \qquad ( 1 )$$

wᵢⱼ^{(l)} represents the weighting set for the spike signal transmission path from the j-th spiking neuron model in the (l−1)-th layer to the target model. The weighting wᵢⱼ^{(l)} is a target to be learned.

θ represents a step function and is represented by Expression (2).

$$( Expression ( 2 ) )$$

$$θ ( x ) = \{ \begin{matrix}0 , ( x < 0 ) \\ 1 , ( x \geq 0 )\end{matrix} \qquad ( 2 )$$

At the time tᵢ^{*(l)}, the membrane potential vᵢ^{(l)}(t) of the target model attains the firing threshold value Vₜₕ, and the target model fires. The firing causes the membrane potential vᵢ^{(l)}(t) of the target model to become 0, and thereafter, the membrane potential does not vary even when a spike signal is input to the target model.

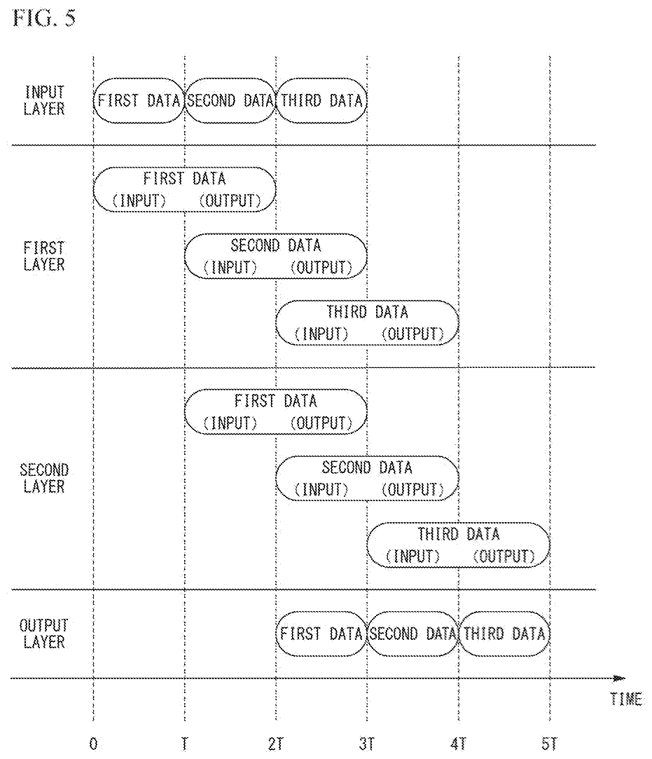

FIG. 4 is a diagram illustrating an example of the output timings of spike signals from spiking neuron models in a spiking neural network in the case in which the output timings of the spike signals from the spiking neuron models are not restricted.

The horizontal axis in FIG. 4 represents the time in terms of the elapsed time from the moment data starts being input to the spiking neural network. The vertical axis represents node numbers in each of the input layer, the first layer, the second layer and the output layer. The node numbers in each layer are used as identification numbers for identifying spiking neuron models in the layer.

In the example in FIG. 4, the spiking neuron models in the input layer fire within a time period of approximately 5 milliseconds from the moment data starts being input to the spiking neural network. In contrast therewith, the firing timings of the spiking neuron models in the first layer are scattered within a range from approximately 10 milliseconds to approximately 120 milliseconds in terms of the elapsed time from the moment data starts being input to the spiking neural network. The firing timings of the spiking neuron models in the second layer are scattered within a range from approximately 20 milliseconds to approximately 70 milliseconds in terms of the elapsed time from the moment data starts being input to the spiking neural network.

Generally, it is difficult to know in real time, during the processing in a spiking neural network, the firing timings of the spiking neural network and which of the firing spiking neuron models in the first layer and the second layer are affecting the firing of the spiking neuron models in the output layer.

For this reason, though it also depends on the scheme of the spiking neural network, there is a need to wait for at least the time period T11, until the spiking neuron models first fire in the output layer, before inputting the next input data to the spiking neural network.

In contrast therewith, in the case in which there are multiple items of input data, if the next input data can be input to the spiking neural network before the computation results for one item of input data are obtained, then the time period from when the first input data is input to the spiking neural network until the computation results for the final input data are obtained can be made relatively shorter, and on this point, the throughput of the spiking neural network can be increased.

Therefore, in the neural network apparatus 10, a data processing period is set for the neuron models 100, and the neuron models 100 are made to complete prescribed processing within the data processing period.

Specifically, the index value calculation unit 110 calculates the membrane potential based on input data that is input in the form of a spike signal in each prescribed time interval. The time width of this time interval is an example of a data processing period. Furthermore, the detection unit 120 detects the occurrence timings of prescribed events relating to the membrane potential calculated by the index value calculation unit 110 in each time interval. Each time the detection unit 120 detects an event occurrence timing, the delay unit 130 determines an output timing of a spike signal within the time interval following the time interval in which that timing is included. The signal output unit 140 outputs a spike signal at the timing determined by the delay unit 130 in each time interval. The spike signal output by the signal output unit 140 is output data from a neuron model 100.

As a result thereof, the neuron model 100 receives a data input in each time interval. Furthermore, the neuron model 100 sequentially processes input data in a period corresponding to two time intervals, and outputs data in each time interval.

FIG. 5 is a diagram illustrating an example of data processing timings for each layer in the neural network apparatus 10. Taking the case of the four-layer structure illustrated in FIG. 2 as an example, FIG. 5 indicates the timings by which each of the nodes 30 in the input layer 21, a first layer (intermediate layer 22-1) of the intermediate layers, a second layer (intermediate layer 22-2) of the intermediate layers and an output layer 23 process data. In both the first layer and the second layer, neuron models 100 are used as the nodes 30.

The horizontal axis in FIG. 5 represents the time in terms of the elapsed time from the moment data starts being input to the neural network apparatus 10.

In the example in FIG. 5, the time represented by the horizontal axis is divided into time intervals and each of the time intervals has a time width T.

The neural network apparatus 10 synchronizes and sets the same time intervals between the neuron models 100 so that time intervals with the same time width are set with the same timings in all of the neuron models 100.

Alternatively, if the delay time for transmission of the spike signals cannot be ignored, then the neural network apparatus 10 may, in each layer, synchronize and set the same time intervals in all of the neuron models 100 in that layer, and between layers, set time intervals that are shifted by times equivalent to the delay times for transmission of the spike signals.

The nodes 30 in the input layer 21 output data to the nodes 30 in the first layer in the form of a spike signal in each time interval. In the example in FIG. 5, the nodes 30 in the input layer 21 output three items of data, namely, first data, second data and third data, to the nodes 30 in the first layer. However, the number of items of data output by the nodes 30 in the input layer 21 is not limited to a specific number.

Each time data inputs are received from the nodes 30 in the input layer 21, the nodes 30 in the first layer output intermediate data for processing that data to the nodes 30 in the second layer in the form of spike signals in the time interval following the time interval in which the data inputs were received. For example, the nodes 30 in the first layer receive inputs of first data in the time interval from the time 0 to T, and output, to the nodes 30 in the second layer, intermediate data for processing the first data in the time interval from the time T to 2T.

Each time data inputs are received from the nodes 30 in the first layer, the nodes 30 in the second layer output intermediate data for processing that data to the nodes 30 in the output layer in the form of spike signals in the time interval following the time interval in which the data inputs were received. For example, the nodes 30 in the second layer receive inputs of the intermediate data for processing the first data in the time interval from the time T to 2T, and output, to the nodes 30 in the output layer, intermediate data obtained by further processing the data from the nodes 30 in the first layer in the time interval from the time 2T to 3T.

Each time data inputs are received from the nodes 30 in the second layer, the nodes 30 in the output layer output, in the form of spike signals, output data obtained by further processing that data.

The output data from the nodes 30 in the output layer are not further input to nodes. Thus, in the example in FIG. 5, the nodes 30 in the output layer output the data in the time intervals in which the data inputs were received.

Thus, with the neural network apparatus 10, since the time intervals during which data processing is performed (completed) are predetermined, the processing of data can begin without waiting for the processing of the previous data to be completed.

Additionally, in the neural network apparatus 10, as in the examples of the first layer and the second layer, the neuron models 100 output spike signals in the time intervals following the time intervals in which spike signal inputs were received. As a result thereof, the neuron models 100 can adjust the timing of spike signal outputs in the time intervals. By adjusting the spike signal output timings, the neural network apparatus 10 can, for example, avoid situations in which the spike signal input timings in layers on the downstream side in the signal transmission tend to occur later in the time intervals (near the ends of the time intervals).

In order to perform data processing at the timings indicated in the example in FIG. 5, as mentioned above, the neuron models 100, in accordance with the spike signal input conditions in each time interval, output spike signals in the following time interval.

Hereinafter, as explained in connection with the spiking neural network by referring to Expression (1) and Expression (2), the neuron model 100 that is the i-th node in the l-th layer will be referred to as the target model, and the membrane potential of the target model will be represented by vᵢ^{(l)}(t). Additionally, the weighting set on the spike signal transmission path from the j-th spiking neuron model in the (l−1)-th layer to the target model will be represented by wᵢⱼ^{(l)}.

The index value calculation unit 110, in each time interval, varies the membrane potential based on the input conditions of spike signals to the neuron models 100 in that time interval. The index value calculation unit 110 is an example of index value calculation means.

The index value calculation unit 110 calculates the membrane potential vᵢ^{(l)}(t), the equation for the derivative of which is represented by Expression (1), until the earlier event of Event (1) or Event (1) occurs. Event (1) is an event in which the membrane potential vᵢ^{(l)}(t) attains the threshold value Vₜₕ. Event (2) is an event in which the time interval has ended. The membrane potential vᵢ^{(l)}(t) is represented by Expression (3).

$$( Expression ( 3 ) )$$

$${v}_{i}^{( l )} ( t ) = {\sum }_{j} {w}_{i j}^{( l )} ( t - {t}_{j}^{* ( l - 1 )} ) θ ( t - {t}_{j}^{* ( l - 1 )} ) \qquad ( 3 )$$

The index value calculation unit 110 may calculate the membrane potential based on Expression (3).

On the other hand, at timings at which the membrane potential vᵢ^{(l)}(t) has attained the threshold value Vₜₕ, or at timings at which the time interval has ended, the index value calculation unit 110 resets the value of the membrane potential vᵢ^{(l)}(t) to 0. The index value calculation unit 110 maintains the value of the membrane potential vᵢ^{(l)}(t) at 0 until the next time interval starts. As a result thereof, the index value calculation unit 110 starts calculating the membrane potential vᵢ^{(l)}(t) in the respective time intervals from a state in which the value of the membrane potential vᵢ^{(l)}(t) is 0.

When the time at which the membrane potential vᵢ^{(l)}(t) attains the threshold value Vₜₕ is represented by tᵢ^{(l, vth)} and is substituted for the time t in Expression (3), Expression (4) is obtained.

$$( Expression ( 4 ) )$$

$${V}_{th} = {ν}_{i}^{( l )} ( {t}_{i}^{( l , vth )} ) = {\sum }_{j ∈ {Γ}_{i}^{( l )}} {w}_{ij}^{( l )} ( {t}_{i}^{( l , v t h )} - {t}_{j}^{* ( l - 1 )} ) \qquad ( 4 )$$

Γᵢ^{(l)} represents the set of indices j for which “tⱼ^{*(l-1)}<tᵢ^{(l, vth)}” is satisfied.

In the neural network apparatus 10, the firing times are restricted to occur only during the output time intervals. Therefore, there are cases in which the firing time tᵢ^{*(l)} is a time later than the time at which the threshold value Vₜₕ is attained. Since there are cases in which the time at which the membrane potential vᵢ^{(l)}(t) attains the threshold value Vₜₕ is different from the firing time tᵢ^{*(l)}, the times at which the membrane potential vᵢ^{(l)}(t) attains the threshold value Vₜₕ are represented by tᵢ^{(l, vth)}. The times at which the membrane potential attains the threshold value will also be referred to as threshold value attainment times.

From Expression (4), the threshold value attainment times tᵢ^{(l, vth)} can be expressed as in Expression (5).

$$( Expression ( 5 ) )$$

$${t}_{i}^{( l , ν th )} = \frac{{V}_{th} + {\sum }_{j ∈ {Γ}_{i}^{( l )}} {w}_{ij}^{( l )} {t}_{j}^{* ( l - 1 )}}{{\sum }_{j ∈ {Γ}_{i}^{( l )}} {w}_{ij}^{( l )}} \qquad ( 5 )$$

The detection unit 120 detects the occurrence timings of prescribed events relating to the membrane potential. The detection unit 120 is an example of detection means.

The prescribed events relating to the membrane potential mentioned here may be the membrane potential attaining a prescribed threshold value, or the membrane potential not attaining the prescribed threshold value by the time the data processing period ends. The occurrence timings of prescribed events relating to the membrane potential mentioned here may be timings at which the membrane potential attains the prescribed threshold value, or may be when the data processing period ends.

The occurrence timings of the prescribed events relating to the membrane potential detected by the detection unit 20 will also be referred to as event occurrence timings. When the membrane potential vᵢ^{(l)}(t) attains the threshold value Vₜₕ within a time interval, the detection unit 120 detects the timing at which the membrane potential vᵢ^{(l)}(t) attains the threshold value Vₜₕ as an event occurrence timing. On the other hand, if the membrane potential vᵢ^{(l)}(t) does not attain the threshold value Vₜₕ within the time interval, then the detection unit 120 detects the time at which that time interval ends as an event occurrence timing.

The delay unit 130 determines the timing at which a neuron model 100 outputs a spike signal. In particular, the delay unit 130 determines, for each time interval, the timing at which the neuron model 100 is to output a spike signal, based on an event occurrence timing in the previous time interval.

Specifically, the delay unit 130 detects timings that are delayed from the event occurrence timings by a time period determined by prescribed conditions. The timings that are delayed from the event occurrence timings by a time period determined by prescribed conditions detected by the delay unit 130 will also be referred to as post-delay timings.

In the case in which a post-delay timing is included in the same time interval as an event occurrence timing, the delay unit 130 determines the timing at which the neuron model 100 is to output a spike signal to be the time at which the time interval following that time interval is to start.

In the case in which the time interval including the post-delay timing is the time interval following the time interval that includes the event occurrence timing, the delay unit 130 determines the timing at which the neuron model 100 is to output a spike signal to be the post-delay timing.

In the case in which a post-delay timing is not detected during the time interval following the time interval including the event occurrence timing, the delay unit 130 determines the timing at which the neuron model 100 is to output a spike signal to be the end of the time interval following the time interval including the event occurrence timing.

The signal output unit 140 outputs spike signals at the timings determined by the delay unit 130. As a result thereof, the signal output unit 140 outputs spike signals at timings that are within a first time interval among the time intervals and that correspond to the occurrence timings of prescribed events in a second time interval, which is a time interval that is further in the past than the first time interval. In this case, the first time interval is a time interval in which the neuron model 100 outputs a spike signal. The second time interval is a time interval in which the neuron model 100 receives a spike signal input that is to serve as the basis for determining the spike signal output timing in the first time interval.

The signal output unit 140 is an example of signal output means.

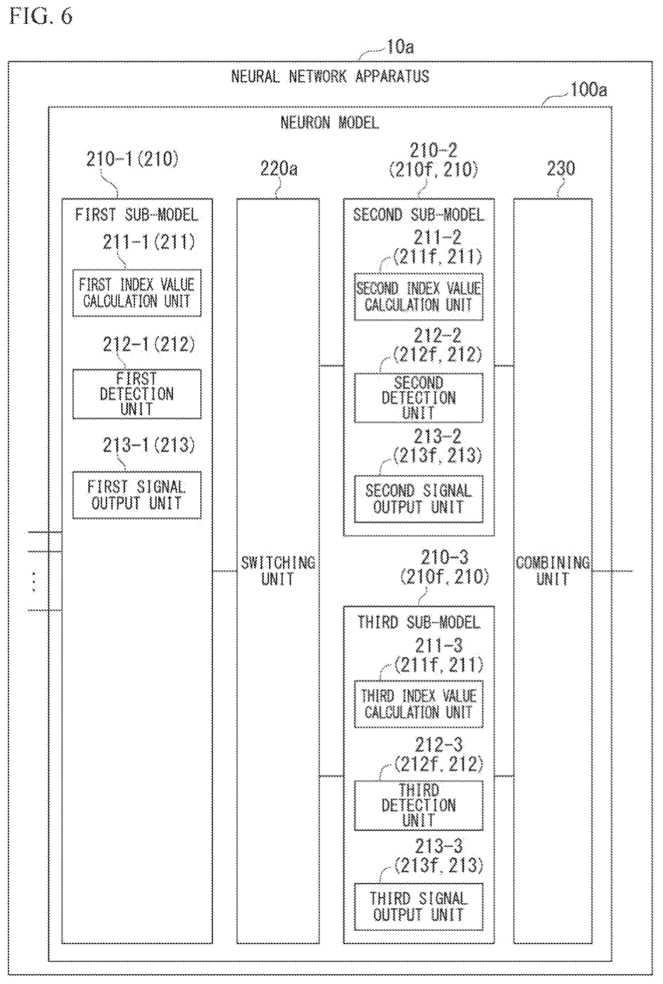

FIG. 6 is a diagram illustrating a first example of a more specific structure of the neural network apparatus. In the structure illustrated in FIG. 6, the neural network apparatus 10a includes a neuron model 100a. The neuron model 100a includes a first sub-model 210-1, a switching unit 220a, a second sub-model 210-2, a third sub-model 210-3 and a combining unit 230. The first sub-model 210-1 includes a first index value calculation unit 211-1, a first detection unit 212-1 and a first signal output unit 213-1. The second sub-model 210-2 includes a second index value calculation unit 211-2, a second detection unit 212-2 and a second signal output unit 213-2. The third sub-model 210-3 includes a third index value calculation unit 211-3, a third detection unit 212-3 and a third signal output unit 213-3.

The first sub-model 210-1, the second sub-model 210-2 and the third sub-model 210-3 will also be referred to collectively as sub-models 210. The second sub-model 210-2 and the third sub-model 210-3 will also be referred to collectively as delaying sub-models 210f.

The first index value calculation unit 211-1, the second index value calculation unit 211-2 and the third index value calculation unit 211-3 will also be referred to collectively as index value calculation units 211. The second index value calculation unit 211-2 and the third index value calculation unit 211-3 will also be referred to collectively as delaying index value calculation units 211f.

The first detection unit 212-1, the second detection unit 212-2 and the third detection unit 212-3 will also be referred to collectively as detection units 212. The second detection unit 212-2 and the third detection unit 212-3 will also be referred to collectively as delaying detection units 212f.

The first signal output unit 213-1, the second signal output unit 213-2 and the third signal output unit 213-3 will also be referred to collectively as signal output units 213. The second signal output unit 213-2 and the third signal output unit 213-3 will also be referred to collectively as delaying signal output units 213f.

The sub-models 210 are configured as spiking neuron models. Specifically, the index value calculation units 211 time-vary the membrane potentials based on spike signal input conditions to the sub-models 210. The first sub-model 210-1 is an example of a first spiking neuron model. The two delaying sub-models 210f are examples of two second spiking neuron models.

The detection units 212 detect occurrence timings of prescribed events relating to membrane potentials.

Specifically, the first detection unit 212-1 compares the membrane potential with a prescribed threshold value. When the membrane potential attains the threshold value within a time interval, the first detection unit 212-1 detects the timing at which the membrane potential attains the threshold value. In the case in which the time interval ends without the membrane potential attaining the threshold value, the first detection unit 212-1 detects the ending timing of that time interval.

In the delaying sub-models 210f, the time intervals are divided between time intervals in which the delaying sub-models 210f receive spike signal inputs and time intervals in which the delaying sub-models 210f output spike signals. The time intervals in which the delaying sub-models 210f receive spike signal inputs will also be referred to as input time intervals. The time intervals in which the delaying sub-models 210f output spike signals will also be referred to as output time intervals.

The input time intervals are time intervals in which the delaying sub-models 210f receive spike signal inputs from the first sub-model 210. The output time intervals are the time intervals following the input time intervals.

The delaying detection units 212f compare the membrane potential with a prescribed threshold value. In the cases in which the membrane potential attains the threshold value within an output time interval, the detection units 212 detect the timing at which the membrane potential attains the threshold value. In the cases in which an output time interval ends without the membrane potential attaining the threshold value, the detection units 212 detect the ending timing of that time interval.

Additionally, in the cases in which the membrane potential attains the threshold value within an input time interval, the delay detection units 212f detect the starting timing of the next time interval. In this case, “the next time interval” is an output time interval.

The signal output units 213 output spike signals at the occurrence timings of the prescribed events detected by the detection units 120.

For example, the first signal output unit 213-1 outputs a spike signal at a timing detected by the first detection unit 212-1, which is a timing at which the membrane potential attains a threshold value, or in the case in which a time interval ends without the membrane potential attaining the threshold value, the ending timing of that time interval.

Additionally, the delaying signal output units 213f output spike signals at timings detected by the delaying detection units 212f, which are a timing at which the membrane potential attains the threshold value within an output time interval, or in the case in which an output time interval ends without the membrane potential attaining the threshold value, at the end timing of that time interval, or in the case in which the membrane potential attains the threshold value within an input time interval, at the start timings of the next time interval.

The switching unit 220a switches the transmission destinations of spike signals from the first sub-model 210-1 to either of the two delaying sub-models 210f.

The combining unit 230 combines the spike signals output respectively from the two delaying sub-models 210f.

In this case, combining the spike signals may involve performing an OR operation on the spike signals respectively output from the two delaying sub-models 210f Specifically, either one of the two delaying sub-models 210f outputs a spike signal in each time interval. In each time interval, the combining unit 230 outputs, as an output to the neuron model 100a, a spike signal output by either one of the delaying sub-models 210f.

The neural network apparatus 10a is an example of the neural network apparatus 10.

The first index value calculation unit 211-1 is an example of the index value calculation unit 110. The first index value calculation unit 211-1 is also an example of index value calculation means.

The first detection unit 212-1 is an example of a detection unit 120. The first detection unit 212-1 is also an example of detection means.

The combination of the delaying index value calculation units 211f and the delaying detection units 212f is an example of the delay unit 130. The combination of the delaying index value calculation units 211f and the delaying detection units 212f is also an example of delay means.

The delaying signal output units 213f are examples of the signal output unit 140. The delaying signal output units 213f are also examples of signal output means.

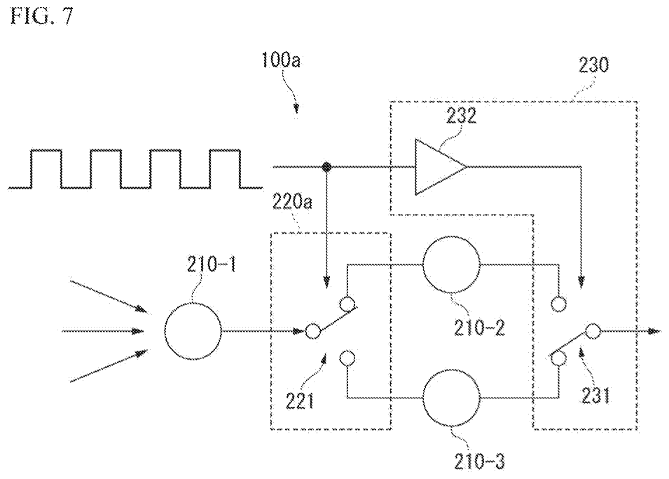

FIG. 7 is a diagram illustrating an example of the structures of the switching unit 220a and the combining unit 230.

In the example in FIG. 7, the switching unit 220a is configured to include a switch 221. The switching unit 220a switches (operates) the switch 221 in each time interval based on an input clock signal. As a result thereof, the switching unit 220a switches, in each time interval, the delaying sub-model 210f that is the output destination of the spike signal from the first sub-model 210-1.

The switching unit 220a is an example of switching means.

The combining unit 230 is configured to include a switch 231 and an inverter 232. The combining unit 230 inverts an input clock signal with an inverter 232 and switches (operates) the switch 231 in each time interval based on the inverted clock signal. As a result thereof, the combining unit 230, in each time interval, switches the delaying sub-model 210f that is to output a spike signal so as to be the delaying sub-model 210f that will not receive a spike signal input from the first sub-model 210-1.

However, the structures of the switching unit 220a and the combining unit 230 are not limited to the structures illustrated in FIG. 7.

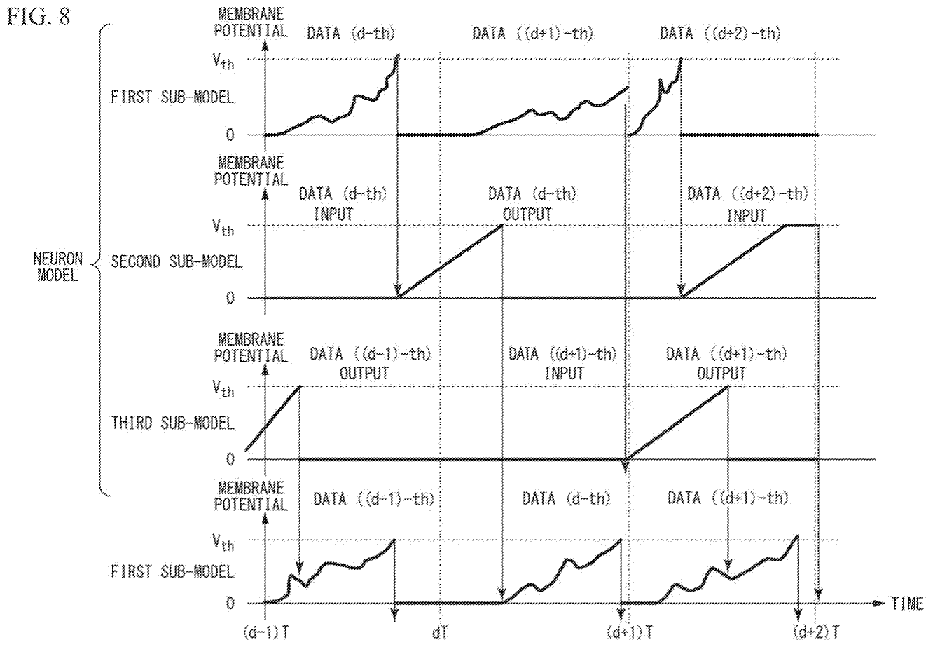

FIG. 8 is a diagram illustrating an example of spike signal transfer timings between the neuron models 100a in the neural network apparatus 10a. FIG. 8 illustrates examples of spike signal transfer between the first sub-model 210-1 and the two delaying sub-models 210f in one neuron model 100a, and of spike signal transfer between the two delaying sub-models 210f and the first sub-model 210-1 of the neuron model 100a that receives the spike signal inputs from the delaying sub-models 210f.

The horizontal axis in the graph in FIG. 8 represents the time in terms of the elapsed time from the moment input data is first input to the neuron model 100a on the side outputting the spike signal in FIG. 8. The vertical axis represents the respective membrane potentials of the first sub-model 210-1, the second sub-model 210-2, the third sub-model 210-3, and the first sub-model 210-1 receiving the spike signal input from the delaying sub-models 210f.

In the example in FIG. 5, as explained regarding the neural network apparatus 10, the time indicated on the horizontal axis in FIG. 8 is divided into time intervals and each of the time intervals has a time width T.

The first sub-model 210-1 is in a state in which the membrane potential has been reset to 0 at the start of a time interval. The first index value calculation unit 211-1 may set the membrane potential to 0 when the first sub-model 210-1 fires, and the setting in which the membrane potential is 0 may be maintained until the next time interval starts.

From the start of the time interval until the first sub-model 210-1 fires, the first index value calculation unit 211-1 time-varies the membrane potential in accordance with the acquisition conditions of a spike signal received in the time interval.

The first sub-model 210-1 fires at a timing at which the membrane potential attains the threshold value. If the membrane potential does not attain the threshold value within the time interval, then the first sub-model 210-1 fires at the end of the time interval.

A firing in a state in which the membrane potential has not attained the threshold value will also be referred to as a forced firing.

The spike signal from the first sub-model 210-1 is input to one of the two delaying sub-models 210f For example, the spike signals when processing oddly numbered data may be input to the second sub-model 210-2 and the spike signals when processing evenly numbered data may be input to the third sub-model 210-3. As described above, the switching unit 220a assigns the spike signal from the first sub-model 210-1 to one of the two delaying sub-models 210f.

The delaying sub-model 210f outputs a spike signal in the time interval following the time interval in which the spike signal input was received from the first sub-model 210-1.

As described above, the time intervals in which the delaying sub-models 210f receive spike signal inputs will also be referred to as input time intervals. The time intervals in which the delaying sub-models 210f output spike signals will also be referred to as output time intervals. The second sub-model 210-2 and the third sub-model 210-3 have opposite input time intervals and output time intervals. That is, when the time interval in the second sub-model 210-2 is an input time interval, the time interval in the third sub-model 210-3 is an output time interval. When the time interval in the second sub-model 210-2 is an output time interval, the time interval in the third sub-model 210-3 is an input time interval.

When an input time interval starts, the membrane potential in a delaying sub-model 210f is in a state of having been reset to 0. The index value calculation unit 211 in the delaying sub-model 210f may set the membrane potential to 0 when the delaying sub-model 210f fires. The delaying sub-model 210f is fired in an output time interval, and the “following time interval” in this case is an input time interval.

The delaying sub-model 210f receives spike signal inputs from only a single first sub-model 210-1 included in the same neuron model 100a as the neuron model 100a in which the delaying sub-model 210f itself is included.

When a spike signal input is received from the first sub-model 210-1, the delaying index value calculation unit 211f increases the membrane potential at a variation rate (variation speed) in accordance with a weighting set on the spike signal transmission path.

In the case in which the membrane potential attains the threshold value within the input time interval, the delaying signal output unit 213f outputs a spike signal at the start of the output time interval. For example, from when the membrane potential attains the threshold value until the start of the output time interval, the delaying index value calculation unit 211f maintains the membrane potential at the same value as the threshold value. Furthermore, when the output time interval starts, the delaying detection unit 212f detects that the membrane potential has attained the threshold value, and the delaying signal output unit 213f outputs a spike signal based on the detection result in the delaying detection unit 212f. After the firing, the delaying index value calculation unit 211f sets the membrane potential to 0.

In the case in which the membrane potential attains the threshold value within an output time interval, the delaying detection unit 212f detects that the membrane potential has attained the threshold value, and the delaying signal output unit 213f outputs a spike signal based on the detection result from the delaying detection unit 212f. After the firing, the delaying index value calculation unit 211f sets the membrane potential to 0.

In the case in which the membrane potential does not attain the threshold value by the end of an output time interval, the delaying signal output unit 213f outputs a spike signal by forced firing. For example, in the case in which the membrane potential has not attained the threshold value even once by the end of an output time interval, the delaying detection unit 212f may output, to the delaying signal output unit 213f, a dummy determination result indicating that the membrane potential has attained the threshold value. Then, the delaying signal output unit 213f may output a spike signal when the output time interval ends based on the dummy determination result from the delaying detection unit 212f. After the firing, the delaying index value calculation unit 211f sets the membrane potential to 0.

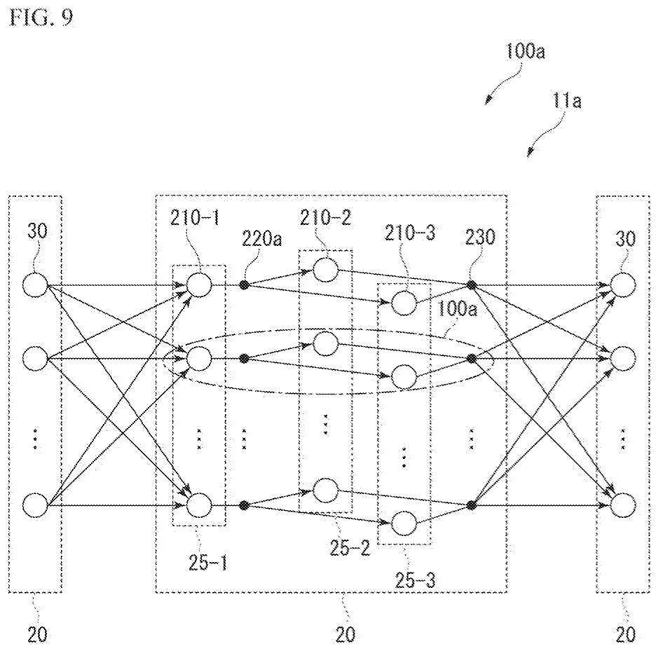

FIG. 9 is a diagram illustrating an example of the structures of sublayers in the neural network apparatus 10a.

A spiking neural network provided in the neural network apparatus 10a is also referred to as a neural network 11a. The neural network 11a is an example of a neural network 11.

In the example in FIG. 9, the layer 20 including the neuron model 100a as the node 30 is formed so as to include sublayers. The sublayer including the first sub-model 210-1 will be referred to as the computation layer, and the reference sign 25-1 is appended thereto. The sublayer including the second sub-model 210-2 will be referred to as the first delay layer, and the reference sign 25-2 is appended thereto. The sublayer including the third sub-model 210-3 will be referred to as the second delay layer, and the reference sign 25-3 is appended thereto.

In the case in which a sublayer is included in an i-th layer (i being a positive integer), the computation layer will also be referred to as the i-th computation layer, the first delay layer will also be referred to as the (i−1)-th delay layer, and the second delay layer will also be referred to as the (i−2)-th delay layer.

When the first sub-model 210-1 outputs a spike signal, the switching unit 220a transmits the spike signal from the first sub-model 210-1 to either of the two delaying sub-models 210f. The spike signal output in the following time interval by the delaying sub-model 210f that has received the spike signal input from the first sub-model 210-1 is input to a node 30 in the next layer 20 via the combining unit 230.

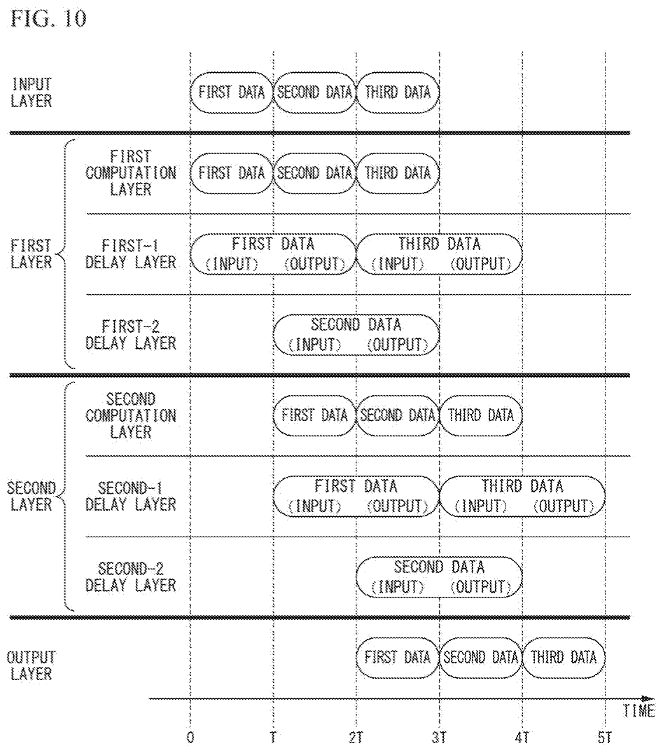

FIG. 10 is a diagram illustrating an example of data processing timings in the neural network apparatus 10a. The horizontal axis in FIG. 10 represents the time in terms of the elapsed time from the moment data starts being input to the neural network 11a. In the example in FIG. 10, the time indicated on the horizontal axis is divided into time intervals and each of the time intervals has a time width T.

Additionally, FIG. 10 illustrates an example of the case in which the neural network 11a is composed of four layers, namely, an input layer, a first layer, a second layer and an output layer, and processes three items of data, namely, first data, second data and third data. For each layer or each sublayer, the time intervals in which the data are processed in that layer or sublayer are indicated.

In the example in FIG. 10, the nodes 30 in the input layer output a single item of data to nodes 30 in the first computation layer in a single time interval.

In the computation layer, the first sub-model 210-1 processes the data within the time interval in which the data input was received, and outputs data as a spike signal to a delaying sub-model 210f in a delay layer. The data processing in the first sub-model 210-1 may be a process for determining the firing timing.

In the delay layers, the delaying sub-models 210f receive the data input in the input time intervals. The delaying sub-models 210f output spike signals, among the timings within the output time intervals, which are the time intervals following the input time intervals, at timings in accordance with the timings at which the data inputs were received in the input time intervals. The delaying sub-models 210f can be considered to output the spike signals received as inputs in the input time intervals after delaying them until the output time intervals.

The nodes 30 in the output layer process the data within the time intervals in which the data inputs are received, and output the processing result data as spike signals.

Due to the processing time for one item of data being defined for each layer in this way, the neural network apparatus 10a can start processing an item of data without waiting for the processing of the previous item of data to end, in the manner of a pipeline processing scheme.

Additionally, the delaying sub-models 210f receive spike signal inputs in input time intervals and output spike signals after delaying them until the output time intervals that are the following time intervals, thereby allowing the output timings of the spike signals in the time intervals to be adjusted. For example, it is possible to avoid situations in which the spike signal inputs in the layers on the downstream side in the data flow tend to be concentrated near the ends of the time intervals.

Additionally, two delaying sub-models 210f are provided for a single first sub-model 210-1, thus allowing the first sub-model 210-1 to output data to the delaying sub-models 210f in each time interval, even if each of the delaying sub-models 210f process a single item of data across two time intervals.

The membrane potential v_{i_1}^{(l)}(t) before the firing of the first sub-model 210-1 in the i-th neuron model 100 in the l-th layer can be expressed as in Expression (6).

$$( Expression ( 6 ) )$$

$${ν}_{{i}_{-} 1}^{( l )} ( t ) = {\sum }_{j} {w}_{ij}^{( l )} ( t - {t}_{j}^{* ( l - 1 )} ) θ ( t - {t}_{j}^{* ( l - 1 )} ) \qquad ( 6 )$$

If the threshold value attainment time in the first sub-model 210-1 is represented by t_{i_1}^{(l, vth)}, then Expression (7) is obtained.

$$( Expression ( 7 ) )$$

$${V}_{t h} = {v}_{{i}_{-} 1}^{( l )} ( {t}_{i \_ 1}^{( l , vth )} ) = {\sum }_{j ∈ {Γ}_{{\dot{ι}}_{-} 1}^{( l )}} {w}_{i j}^{( l )} ( {t}_{{i}_{-} 1}^{( l , vth )} - {t}_{j}^{* ( l - 1 )} ) \qquad ( 7 )$$

Γ_{i_1}^{(l)} represents the set of indices j for which “tⱼ^{*(l-1)}<t_{i_1}^{(l, vth)}” is satisfied. The threshold value attainment time t_{i_1}^{(l, vth)} can be expressed as in Expression (8).

$$( Expression ( 8 ) )$$

$${t}_{{i}_{-} 1}^{( l , v t h )} = \frac{{V}_{t h} + {\sum }_{j ∈ {Γ}_{{i}_{-} 1}^{( l )}} {w}_{ij}^{( l )} {t}_{j}^{* ( l - 1 )}}{{\sum }_{j ∈ {Γ}_{i \_ 1}^{( l )}} {w}_{ij}^{( l )}} \qquad ( 8 )$$

The firing timing t_{i_1}^{*(l)} when this first sub-model 210-1 processes the d-th data can be expressed as in Expression (9).

(Expression (9))

t_{i_1}^{*(l)}=clip(t_{i_1}^{(l,vth)},(l+d−2)T,(l+d−1)T) (9)

The function “clip” is expressed as in Expression (10).

$$( Expression ( 10 ) )$$

$$clip ( x , a , b ) = \{ \begin{matrix}a & when x < a \\ x & when a \leq x < b \\ b & when b \leq x\end{matrix} \qquad ( 10 )$$

The function “clip” expressed by Expression (10) will also be referred to as a clip function.

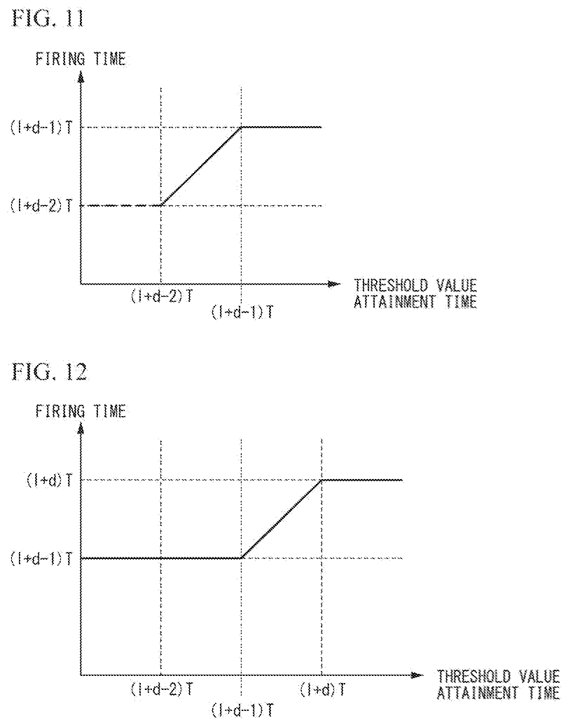

FIG. 11 is a diagram illustrating a first example of a clip function. FIG. 11 illustrates an example of a clip function used when the first sub-model 210-1 in the i-th neuron model 100 in the l-th layer processes d-th data.

The horizontal axis in the graph in FIG. 11 represents the time at which the membrane potential attains the threshold value in terms of the elapsed time from the moment data starts being input to the neural network 11a. The vertical axis represents the firing timing of the first sub-model 210-1 in terms of the elapsed time from the moment data starts being input to the neural network 11a.

The time period from the time (l+d−2)T to (l+d−1)T corresponds to the time interval during which the first sub-model 210-1 in the i-th neuron model 100 in the l-th layer processes the d-th data. In the case in which the membrane potential attains the threshold value within this time interval, the first signal output unit 213-1 outputs a spike signal when the first detection unit 212-1 detects that the membrane potential has attained the threshold value. Meanwhile, in the case in which the membrane potential does not attain the threshold value within this time interval, it can be considered that the membrane potential will attain the threshold value after the time (l+d−1)T. In this case, the first signal output unit 213-1 outputs a spike signal at the time (l+d−1)T, which is when this time interval ends.

The membrane potential v_{i_1}^{(l)}(t) before the firing of the delaying sub-model 210f in the i-th neuron model 100 in the l-th layer can be expressed as in Expression (11).

(Expression (11))

v_{i_f}^{(l)}=w_{f}(t−t_{i_1}^{*(l)})θ(t−t_{i_1}^{*(l)}) (11)

w_{f} indicates a weighting set on the spike signal transmission path from the first sub-model 210_1 to the delaying sub-model 210f. w_{f} may be a target to be learned.

If the threshold value attainment time in this delaying sub-model 210f is represented by t_{i_f}^{(l, vth)}, then Expression (12) is obtained.

(Expression (12))

Vₜₕ=v_{i_f}^{(l)}(t_{i_f}^{(l,vth)})=w_{f}(t_{i_f}^{(l,vth)}−t_{i_1}^{*(l)}) (12)

The threshold value attainment time t_{i_f}^{(l, vth)} can be expressed as in Expression (13).

$$( Expression ( 13 ) )$$

$${t}_{{i}_{- f}}^{( l , vth )} = \frac{{V}_{t h} + {w}_{f} {t}_{{i}_{-} 1}^{* ( l )}}{{w}_{f}} \qquad ( 13 )$$

The firing time t_{i_f}^{*(l)} when this delaying sub-model 210f processes the d-th data can be expressed as in Expression (14).

(Expression (14))

t_{i_f}^{*(l)}=clip(t_{i_f}^{(l,vth)},(l+d−1)T,(l+d)T) (14)

FIG. 12 is a diagram illustrating a second example of a clip function. FIG. 12 illustrates an example of a clip function used when a delaying sub-model 210f in the i-th neuron model 100 in the l-th layer processes d-th data.

The horizontal axis in the graph in FIG. 12 represents the time at which the membrane potential attains the threshold value in terms of the elapsed time from the moment data starts being input to the neural network 11a. The vertical axis represents the firing time of the delaying sub-model 210f in terms of the elapsed time from the moment data starts being input to the neural network 11a.

The time period from the time (l+d−2)T to (l+d−1)T corresponds to the input time interval during which the delaying sub-model 210f in the i-th neuron model 100 in the l-th layer processes the d-th data. The time period from the time (l+d−1)T to (l+d)T corresponds to the output time interval during which the delaying sub-model 210f in the i-th neuron model 100 in the l-th layer processes the d-th data.

In the case in which the membrane potential attains the threshold value within an input time interval, the delaying signal output unit 213f outputs a spike signal at the start of the output time interval that is the time interval following this input time interval.

In the case in which the membrane potential attains the threshold value within the output time interval, the delaying signal output unit 213f outputs a spike signal when the delaying detection unit 212f detects that the membrane potential has attained the threshold value.

In the case in which the membrane potential does not attain the threshold value by the end of the output time interval, it can be considered that the membrane potential will attain the threshold value after the time (l+d)T. In this case, the delaying signal output unit 213f outputs a spike signal at the time (l+d)T, which is when the output time interval ends.

FIG. 13 is a diagram illustrating a first example of a function indicating the timing at which the i-th neuron model 100a in the l-th layer processes d-th data.

The horizontal axis in the graph in FIG. 13 represents the time at which the membrane potential in the first sub-model 210-1 attains the threshold value in terms of the elapsed time from the moment data starts being input to the neural network 11a. The vertical axis represents the firing time of the delaying sub-model 210f in terms of the elapsed time from the moment data starts being input to the neural network 11a.

The time at which the membrane potential in the first sub-model 210-1 attains the threshold value can be treated as the same time as the firing time of the first sub-model 210-1. Additionally, the time at which the membrane potential in the first sub-model 210-1 attains the threshold value can be treated as the same time as the time at which the delaying sub-model 210f receives the spike signal input.

FIG. 13 illustrates an example of the case in which the time period from when the delaying sub-model 210f receives a spike signal input until it outputs a spike signal is T. The time period from when the delaying sub-model 210f receives a spike signal input until it outputs a spike signal is also referred to as the delay time of the delaying sub-model 210f.

In the case in which the delay time of the delaying sub-model 210f is T, the delaying sub-model 210f outputs a spike signal at a timing within the output time interval that is the same as the timing at which the spike signal input was received within the input time interval. The same timing within two time intervals mentioned here may mean that the elapsed time from the start of the each time interval is the same.

In FIG. 13, the elapsed time from the time (l+d−2)T until the threshold value attainment time in the first sub-model 210-1 is equal to the elapsed time from the time (l+d−1)T to the firing time of the delaying sub-model 210f.

In this case, the time (l+d−2)T is when the input time interval starts. The time (l+d−1)T is when the output time interval starts. Additionally, it is assumed that the delay time from when the membrane potential in the first sub-model 210-1 attains the threshold value until when the delaying sub-model 210f receives the spike signal input can be ignored.

Therefore, FIG. 13 illustrates the case in which the delaying sub-model 210f outputs a spike signal at a timing within the output time interval that is the same as the timing at which the spike signal input was received in the input time interval.

In the case in which the delay time of the delaying sub-model 210f is equal to the time width of a time interval, the timing at which the membrane potential in the first sub-model 210-1 attains the threshold value within the time interval is directly reflected in the timing at which the delaying sub-model 210f fires within the output time interval. For this reason, it can be considered that information is not lost.

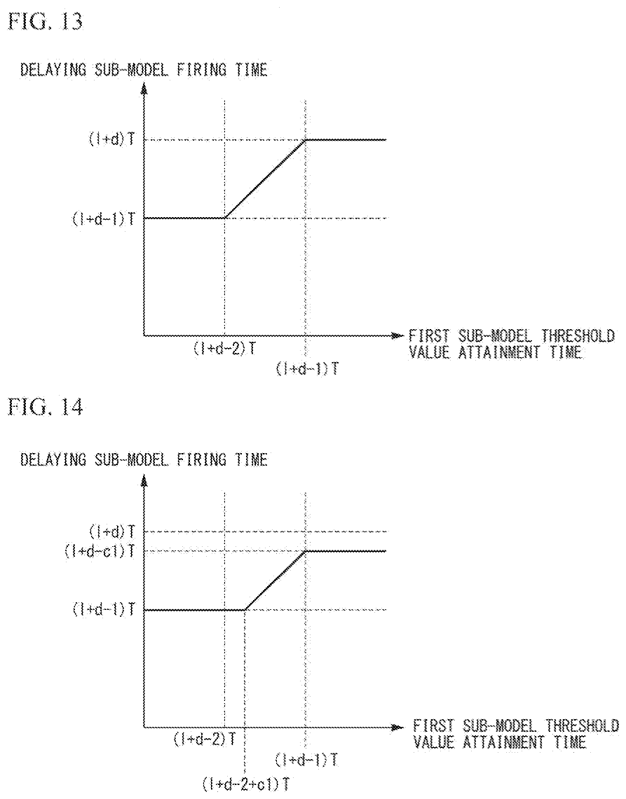

FIG. 14 is a diagram illustrating a second example of a function indicating the timing at which the i-th neuron model 100a in the l-th layer processes d-th data.

The horizontal axis in the graph in FIG. 14 represents the time at which the membrane potential in the first sub-model 210-1 attains the threshold value in terms of the elapsed time from the moment data starts being input to the neural network 11a. The vertical axis represents the firing time of the delaying sub-model 210f in terms of the elapsed time from the moment data starts being input to the neural network 11a.

FIG. 14 indicates an example of the case in which the delay time of the delaying sub-model 210f is shorter than T.

In the case in which the delay time of the delaying sub-model 210f is shorter than T, the timing at which the delaying sub-model 210f fires within the output time interval becomes earlier than the timing at which the first sub-model 210-1 fires within the time interval.

In the example in FIG. 14, in the case in which the membrane potential in the first sub-model 210-1 attains the threshold value between the times (l+d−2)T and (l+d−2+c1)T, the delaying sub-model 210f fires at the time (l+d−1)T, which is when the output time interval starts.

Additionally, in the case in which the membrane potential in the first sub-model 210-1 attains the threshold value between the times (l+d−2+c1)T and (l+d−1)T, the delaying sub-model 210f fires after the time period T−c1 has elapsed. In terms of the timings within the time intervals, the timing at which the delaying sub-model 210f fires within the output time interval becomes earlier, by the time period c1, than the timing at which the first sub-model 210-1 fires within the time interval.

By making the timing earlier in this way, the spike signal output timing in the time interval can be adjusted. For example, it is possible to avoid situations in which the spike signal inputs in layers on the downstream side in the data flow tend to be concentrated near the ends of the time intervals.

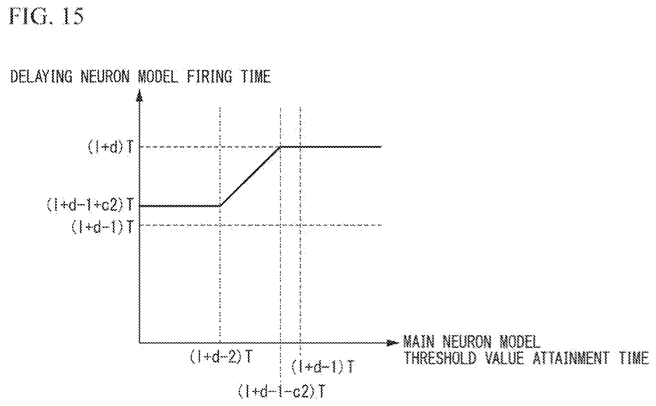

FIG. 15 is a diagram illustrating a third example of a function indicating the timing when the i-th neuron model 100a in the l-th layer processes d-th data.

The horizontal axis in the graph in FIG. 15 represents the time at which the membrane potential in the first sub-model 210-1 attains the threshold value in terms of the elapsed time from the moment data starts being input to the neural network 11a. The vertical axis represents the firing time of the delaying sub-model 210f in terms of the elapsed time from the moment data starts being input to the neural network 11a.

FIG. 15 indicates an example of the case in which the delay time of the delaying sub-model 210f is longer than T.

In the case in which the delay time of the delaying sub-model 210f is longer than T, the timing at which the delaying sub-model 210f fires within the output time interval becomes later than the timing at which the first sub-model 210-1 fires within the time interval.

In the example in FIG. 15, in the case in which the membrane potential in the first sub-model 210-1 attains the threshold value between the times (l+d−2)T and (l+d−1−c2)T, the delaying sub-model 210f fires after the time period T+c2 has elapsed. In terms of the timing within the time intervals, the timing at which the delaying sub-model 210f fires within the output time interval becomes later, by the time period c2, than the timing at which the first sub-model 210-1 fires within the time interval.

Additionally, in the case in which the membrane potential of the first sub-model 210-1 attains the threshold value between the times (l+d−1−c2)T and (l+d−1)T, the delaying sub-model 210f fires at the time (l+d)T, which is when the output time interval ends.

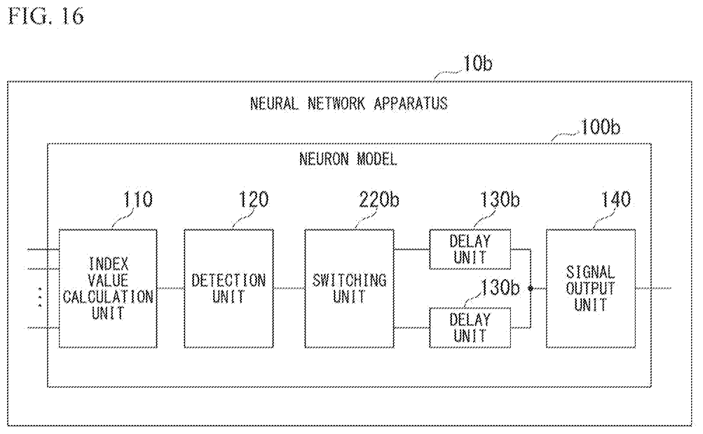

FIG. 16 is a diagram illustrating a second example of a more specific structure of the neural network apparatus.

In the structure illustrated in FIG. 16, the neural network apparatus 10b includes a neuron model 100b. The neuron model 100b includes an index value calculation unit 110, a detection unit 120, delay units 130b, a signal output unit 140 and a switching unit 220b.

In the units in FIG. 16, those portions having functions similar to and corresponding to the respective units in FIG. 1 are assigned the same reference signs (110, 120, 140) and detailed descriptions thereof will be omitted.

The neural network apparatus 10b is an example of the neural network apparatus 10, and the neuron model 100b is an example of the neuron model 100. In FIG. 16, as the structure of the neuron model 100b, delay units 130b are illustrated instead of the delay unit 130 in the structure of the neuron model 100 in FIG. 1, and a switching unit 220b is further illustrated.

The switching unit 220b switches, between the two delay units 130b, the transfer destinations of signals from the detection unit 120 indicating that the membrane potential has attained the threshold value. The switching unit 220b differs from the switching unit 220a in the neural network apparatus 10a in that the signals indicating that the membrane potential has attained the threshold value are not limited to being spike signals. In the case in which spike signals are used as the signals indicating that the membrane potential has attained the threshold value, the switching unit 220b is the same as the switching unit 220a. The switching unit 220a is an example of the switching unit 220b. The switching unit 220b is an example of switching means.

The delay unit 130b outputs, to the signal output unit 140, signals instructing to fire, within time intervals following time intervals in which signal inputs indicating that the membrane potential has attained the threshold value are received, at timings in accordance with the timings at which the signal inputs were received from the detection unit 120.

As a result thereof, the signal output unit 140, as explained above, outputs spike signals at timings that are within a first time interval among the time intervals and that correspond to the occurrence timings of prescribed events in a second time interval, which is a time interval that is further in the past than the first time interval.

The delay units 130b are examples of the delay unit 130. The delay units 130b are also examples of delay means.

A signal obtained by performing an OR operation on the signals output from the two delay units 130b is input to the signal output unit 140. Therefore, no matter which of the two delay units 130b has output a signal instructing to fire, the signal output unit 140 outputs a spike signal.

In the case in which the delay units 130b are formed using spiking neuron models, the delay units 130b are the same as the sub-models 210. The sub-models 210 are examples of the delay units 130b. However, the structures of the delay units 130b are not limited to structures using spiking neuron models. For example, the delay units 130b may be formed so as to be provided with timers, and the time from when a signal input is received until a signal is output may be measured by using the timers.

The signal output unit 140 outputs spike signals in response to the signals instructing to fire from the delay units 130b. In the case in which the signals from the delay units 130b are spike signals, the signal output unit 140 may output the spike signals from the delay units 130b as they are.

In the case in which the time obtained by adding a prescribed delay time to the time at which the detection unit 120 detected the occurrence of an event is included within the same time interval as the time interval in which the detection unit 120 detected the occurrence of the event, the process by which the signal output unit 140 outputs a spike signal when the following time interval starts may be performed by the delay unit 130b or may be performed by the signal output unit 140.

In the case in which the time obtained by adding the prescribed delay time to the time at which the detection unit 120 detected the occurrence of an event is later than the time interval following the time interval in which the detection unit 120 detected the occurrence of the event, the process by which the signal output unit 140 outputs a spike signal at the end of the time interval following the time interval in which the detection unit 120 detected the occurrence of the event may be performed by the delay unit 130b or may be performed by the signal output unit 140.

In the structure illustrated in FIG. 1, the delay unit 130 may receive signal inputs at multiple times and output signals at times delayed from the respective times. For example, the combination of the switching unit 220b and the two delay units 130b in FIG. 16 is an example of the delay unit 130.

Alternatively, the delay unit 130 may include a path that can receive multiple signals. For example, the delay unit 130 may include a shift register such that, when a signal input is received, the lowest bit in the shift register is set to 1, and the shift register is shifted up with each prescribed clock period. Then, the delay unit 130 may output a signal instructing the signal output unit 140 to fire when the highest bit in the shift register becomes 1.

In the structure illustrated in FIG. 1, in the case in which the time obtained by adding the prescribed delay time to the time at which the detection unit 120 detected the occurrence of an event is within the same time interval as the time interval in which the detection unit 120 detected the occurrence of the event, the process by which the signal output unit 140 outputs a spike signal when the following time interval starts may be performed by the delay unit 130 or may be performed by the signal output unit 140.

In the structure illustrated in FIG. 1, in the case in which the time obtained by adding the prescribed delay time to the time at which the detection unit 120 detected the occurrence of an event is later than the time interval following the time interval in which the detection unit 120 detected the occurrence of the event, the process by which the signal output unit 140 outputs a spike signal at the end of the time interval following the time interval in which the detection unit 120 detected the occurrence of the event may be performed by the delay unit 130 or may be performed by the signal output unit 140.

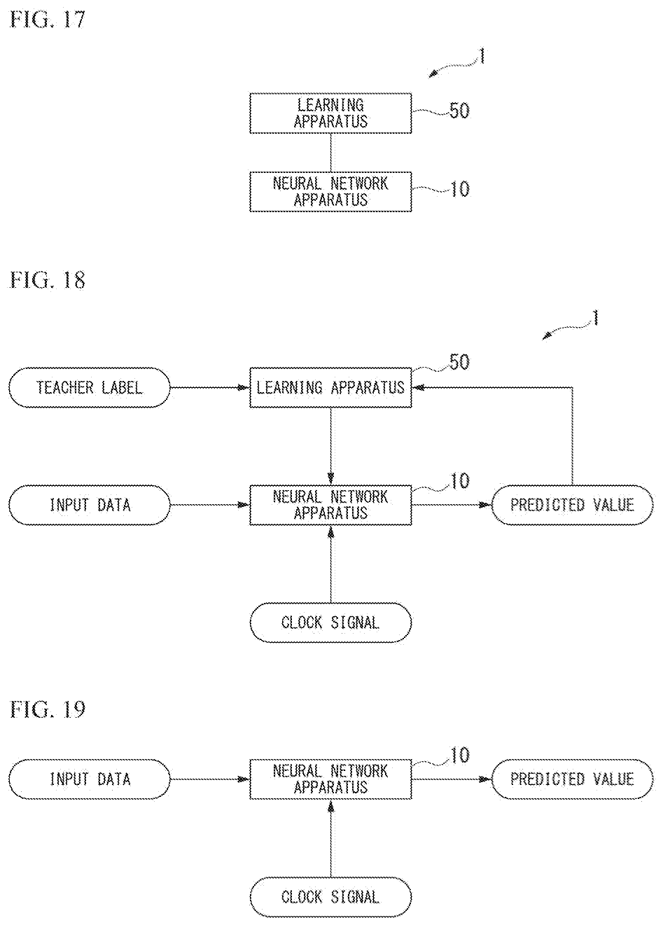

FIG. 17 is a diagram illustrating an example of the system structure when learning. In the structure illustrated in FIG. 17, the neural network system 1 includes a neural network apparatus 10 and a learning apparatus 50. The neural network apparatus 10 and the learning apparatus 50 may be integrally formed in a single apparatus.

Alternatively, the neural network apparatus 10 and the learning apparatus 50 may be arranged to be separate apparatuses.

As mentioned above, the neural network 11 formed by the neural network apparatus 10 will also be referred to as a neural network body.

FIG. 18 is a diagram illustrating an example of input and output of signals in the neural network system 1.

In the example in FIG. 18, input data and teacher labels indicating correct answers to the input data are input to the neural network system 1. The neural network apparatus 10 may receive inputs of input data and the learning apparatus 50 may receive inputs of the teacher labels. Combinations of the input data and the teacher labels are examples of training data in supervised learning.

Additionally, the neural network apparatus 10 acquires clock signals. The neural network apparatus 10 may include a clock circuit. Alternatively, the neural network apparatus 10 may receive inputs of clock signals from outside the neural network apparatus 10.

The neural network apparatus 10 receives inputs of input data and outputs estimated values based on the input data. When computing the estimated values, the neural network apparatus 10 uses the clock signals to synchronize the time intervals between layers and to synchronize the time intervals between neuron models 100 in the same layer.

The learning apparatus 50 implements learning in the neural network apparatus 10. The learning mentioned here refers to adjusting the parameter values of the learning models by means of a machine learning algorithm. The learning apparatus 50 learns weighting coefficients for the spike signals input to the neuron models 100. The weights wᵢⱼ^{(l)} in Expression (4) are examples of weighting coefficients, the values of which are adjusted by the learning of the learning apparatus 50.

The learning apparatus 50 may use an evaluation function indicating evaluations of the error between estimated values output by the neural network apparatus 10 and correct values indicated by the teacher labels to learn the weighting coefficients so that the magnitude of the error between the estimated values and the correct values is decreased.

The learning apparatus 50 is an example of learning means. The learning apparatus 50 is formed by using, for example, a computer.

The learning method performed by the learning apparatus 50 may be a method in which an existing learning method such as, for example, error backpropagation, has been arranged in response to the input time intervals and the output time intervals being set.

For example, in the case in which the learning apparatus 50 implements learning by using a method obtained by arranging an error backpropagation method, the weights wᵢⱼ^{(l)} may be updated to change the weights wᵢⱼ^{(l)} by the change amounts Δwᵢⱼ^{(l)} indicated by Expression (15).

$$( Expression ( 15 ) )$$

$$Δ {w}_{ij}^{( l )} = - η \frac{\partial C}{\partial {w}_{ij}^{( l )}} \qquad ( 15 )$$

η is a constant indicating the learning rate.

C can be expressed as in Expression (16).

$$( Expression ( 16 ) )$$

$$C := - {\sum }_{i = 1}^{{N}^{( M )}} {κ}_{i} ln ( {S}_{i} ( {t}^{( M )} ) ) + \frac{γ}{2} {( {t}_{i}^{⋆ ( M )} - {t}^{( ref )} )}^{2} \qquad ( 16 )$$

C is an example of an evaluation function for indicating evaluations of the error between estimated values output by the neural network apparatus 10 and correct values indicated by the teacher labels. C is set to be a loss function that outputs smaller values as the error becomes smaller.

M represents an index value indicating the output layer (final layer). N^{(M)} represents the number of neuron models 100 included in the output layer.

κᵢ represents a teacher label. In this case, the neural network apparatus 10 performs classification into N^{(M)} classes, and the teacher labels are represented by one-hot vectors. When the value of the index i indicates the correct class, κᵢ=1, and otherwise, κᵢ=0.

t^{(ref)} represents a reference spike.

The term “γ/2(tᵢ^{*(M)}−t^{(ref)2}” is a term that is provided in order to avoid learning difficulties. This term will also be referred to as a temporal penalty term. Due to the temporal penalty term, the firing timings in the output layer are distributed around the reference spike, and as a result thereof, the output neurons fire stably. γ is a constant for adjusting the degree of influence of the temporal penalty term, and γ>0. γ will also be referred to as a temporal penalty coefficient.

Sᵢ is a softmax function and can be expressed as in Expression (17).

$$( Expression ( 17 ) )$$

$${S}_{i} ( {t}^{( M )} ) := \frac{exp ( - \frac{{t}_{i}^{* ( M )}}{{σ}_{soft}} )}{{\sum }_{j = 1}^{{N}^{( M )}} exp ( - \frac{{t}_{j}^{* ( M )}}{{σ}_{soft}} )} \qquad ( 17 )$$

σ_{soft} is a constant that is provided as a scale factor for adjusting how much the value of the softmax function Sᵢ changes when the firing timing of the output layer changes, and σ_{soft}>0. This scale factor makes stable learning possible by having a value that is approximately the same as (from 1/10 of to 10 times) the output time interval.

In Expression (17), the i-th spike firing time tᵢ^{*(M)} in the output layer satisfies the expression 0≤tᵢ^{*(M)}≤1. For example, the spike firing time in the output layer may indicate, for each class, the probability that the classification target indicated by input data will be classified in that class. For values of i such that κᵢ=1, the closer the value of tᵢ^{*(M)} approaches 1, the smaller the value of the term “−Σᵢ₌₁^{N(M)} (κᵢ ln(Sᵢ(t^{*(M)})))” becomes, so that the learning apparatus 50 calculates a smaller loss (the value of the evaluation function C).

However, the processing performed by the neural network apparatus 10 is not limited to classification.

In addition to or instead of the weighting wᵢⱼ^{(l)}, the weighting wt expressed by Expression (11) may be the weighting whose value is to be adjusted by learning.

For example, a value of the weighting wt may be set for each neuron model 100.

In this case, the weighting wt in the i-th neuron model 100 in the l-th layer will be represented by w_{i_f}^{(l)}. In the case in which the learning apparatus 50 performs learning by using a method obtained by arranging the error backpropagation method, the weighting w_{i_f}^{(l)} may be updated so that the weighting w_{i_f}^{(l)} is varied by the variation amount Δw_{i_f}^{(l)} expressed by Expression (18).

$$( Expression ( 18 ) )$$

$$Δ {w}_{{i}_{- f}}^{( l )} = - η \frac{\partial C}{\partial {w}_{{i}_{- f}}^{( l )}} \qquad ( 18 )$$

FIG. 19 is a diagram illustrating an example of input and output of signals in the neural network apparatus 10 during operation.

As with the operation illustrated in FIG. 19, even while learning, the neural network apparatus 10 receives inputs of input data and acquires clock signals. The neural network apparatus 10 may include a clock circuit. Alternatively, the neural network apparatus 10 may receive inputs of clock signals from outside the neural network apparatus 10.

The neural network apparatus 10 receives inputs of input data and outputs estimated values based on the input data. When computing estimated values, the neural network apparatus 10 uses the clock signals to synchronize the time intervals between layers and to synchronize the time intervals between neuron models 100 in the same layers.

The type of the neural network 11 is not limited to a specific type. For example, the neural network 11 may be configured as a convolutional neural network (CNN) using a spiking neural network.

As mentioned above, if the neural network 11 is configured as a feedforward spiking neural network, then it is sufficient for there to be two or more layers in the neural network 11, and the number of layers is not limited to a specific number. Additionally, the number of neuron models 100 provided in each layer is not limited to a specific number, and it is sufficient to provide one or more neuron models 11 in each layer. Each layer may be provided with the same number of neuron models 100, or a different number of neuron models 100 may be provided depending on the layer. Additionally, the neural network 11 may be fully connected, or may not be fully connected.

Additionally, the membrane potentials of the neuron models 100 after firing are not limited so as to be unvarying from a potential of 0 as mentioned above. For example, the membrane potentials may vary in response to the input of spike signals after a prescribed time period has elapsed since firing. The number of times each neuron model 100 fires is also not limited to being a single time for each item of input data.

The structures of the neuron models 100 as spiking neuron models are also not limited to a specific structure. For example, the variation speeds of the neuron models 100 from when spike signal inputs are received until the next spike signal inputs are received need not be fixed.

The learning method in the neural network 11 is not limited to supervised learning. The learning apparatus 50 may implement learning in the neural network 11 by unsupervised learning.

As described above, the index value calculation units 110, in each time interval, time-vary the membrane potential, which is an index value for the spike signal output, based on the spike signal input conditions in that time interval.

The detection units 120 detect the occurrence timings of prescribed events relating to the membrane potential. Specifically, the detection units 120 detects timings at which the membrane potential attains the threshold value and timings at which time intervals end without the membrane potential attaining the threshold value.

The signal output units 140 output spike signals at timings that are within output time intervals among the time intervals and that correspond to the occurrence timings of prescribed events in input time intervals, which are time intervals that are further in the past than the output time intervals.

Due to the neuron models 100 receiving spike signal inputs in each time interval and outputting spike signals in the time intervals following the time intervals in which the spike signal inputs were received, the neural network 11 can receive data inputs in each time interval and process each item of data that has been input.

According to the neural network apparatus 10, due to this feature, the neural network 11 that is a spiking neural network can efficiently perform data processing.

Additionally, by outputting spike signals in the time intervals following the time intervals in which the spike signal inputs are received, the neuron models 100 can adjust the output timings of the spike signals within the time intervals. The neural network apparatus 10 can, for example, avoid situations in which the spike signal inputs in layers on the downstream side in the data flow tend to be concentrated near the ends of the time intervals.

Additionally, the delay units 130 determine the timings at which spike signals are to be output to the signal output units 140 based on timings that are a prescribed time period after the above-mentioned timings detected by the detection units 120. The switching units 220, in each time interval, switch the delay units 130 to which the detection results from the detection units 120 are input between two delay units 130.

The neural network apparatus 10b can deal with the time intervals in which the signal output units 140 output spike signals coinciding (overlapping) with time intervals in which the index value calculation units 110 receive spike signal inputs relating to the next data by means of a relatively simple structure using two delay units 130 and a switching unit 220.

Additionally, when the first detection unit 212-1 detects an occurrence timing of a prescribed event relating to the membrane potential, the first sub-model 210-1 outputs a spike signal to the delaying sub-model 210f. The delaying detection unit 212f determines the timing at which a spike signal is to be output to the delaying signal output unit 213f to be a timing that is a timing within the output time interval and that is based on a timing that is a prescribed time period after the timing at which a spike signal input was received from the first sub-model 210-1 in the input time interval.

In the neural network apparatus 10a, the neuron models 100a can be formed by using spiking neuron models as the first sub-models 210-1 and the delaying sub-models 210f The burden of a designer to design the neural network apparatus 10a can be expected to be relatively light in that there is no need to design means for delaying the signal output separately from the spiking neuron models. Additionally, by using many spiking neuron models, the production cost for each spiking neuron model is reduced, and the production cost of the neural network apparatus 10a as a whole can be expected to be relatively low.

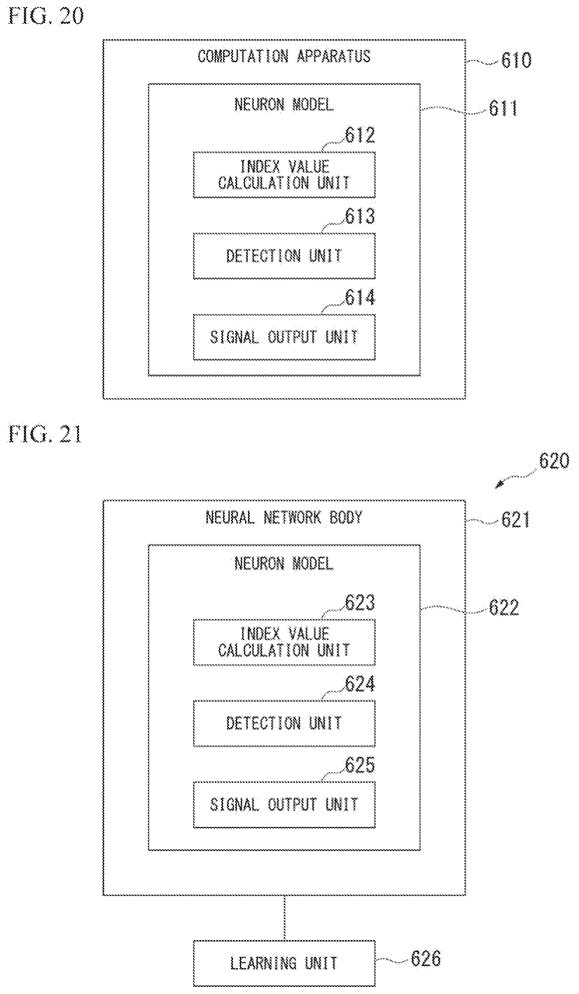

FIG. 20 is a diagram illustrating an example of the structure of a computation apparatus according to an example embodiment. In the structure illustrated in FIG. 20, a computation apparatus 610 includes a neuron model 611. The neuron model 611 includes an index value calculation unit 612, a detection unit 613 and a signal output unit 614.

With this structure, the index value calculation unit 612, in each time interval, varies the index value of a signal output based on the input conditions of a signal during that time interval. The detection unit 613 detects the occurrence timing of a prescribed event relating to the index value. The signal output unit 614 outputs a signal at a timing that is within a first time interval among the time intervals and is in accordance with the occurrence timing of the prescribed events in a second time interval that is a time interval further in the past than the first time interval.

The index value calculation unit 612 is an example of index value calculation means. The detection unit 613 is an example of detection means. The signal output unit 614 is an example of signal output means.

Due to the neuron models 611 receiving spike signal inputs in each time interval and outputting spike signals in time intervals following the time intervals in which the spike signal inputs were received, the computation apparatus 610, which functions as a spiking neural network using the neuron models 611, can receive inputs of data in each time interval and process each item of data that has been input.

According to the computation apparatus 610, due to this feature, a spiking neural network can efficiently perform data processing.

Additionally, the neuron models 611 can adjust the output timings of spike signals in the time intervals by outputting spike signals in the time intervals following the time intervals in which the spike signal inputs were received. The computation apparatus 610 can, for example, avoid situations in which the spike signal inputs in layers on the downstream side in the data flow in the spiking neural network tend to be concentrated near the ends of the time intervals.

FIG. 21 is a diagram illustrating an example of the structure of a neural network system according to an example embodiment.

With the structure illustrated in FIG. 21, the neural network system 620 includes a neural network body 621 and a learning unit 626. The neural network body 621 includes a neuron model 622. The neuron model 622 includes an index value calculation unit 623, a detection unit 624 and a signal output unit 625.

With this structure, the index value calculation unit 623, in each time interval, varies the index value of a signal output based on the input conditions of a spike signal during that time interval. The detection unit 624 detects the occurrence timing of a prescribed event relating to the index value. The signal output unit 625 outputs a signal at a timing that is within a first time interval among the time intervals and that is in accordance with the occurrence timing of the prescribed event in a second time interval that is a time interval further in the past than the first time interval. The learning unit 626 learns weighting coefficients for the signals.

The index value calculation unit 623 is an example of index value calculation means. The signal output unit 625 is an example of signal output means. The learning unit 626 is an example of learning means.

In the neural network system 620, due to these features, weighting coefficients can be adjusted by learning and the estimation accuracy of the neural network body 621 can be improved.

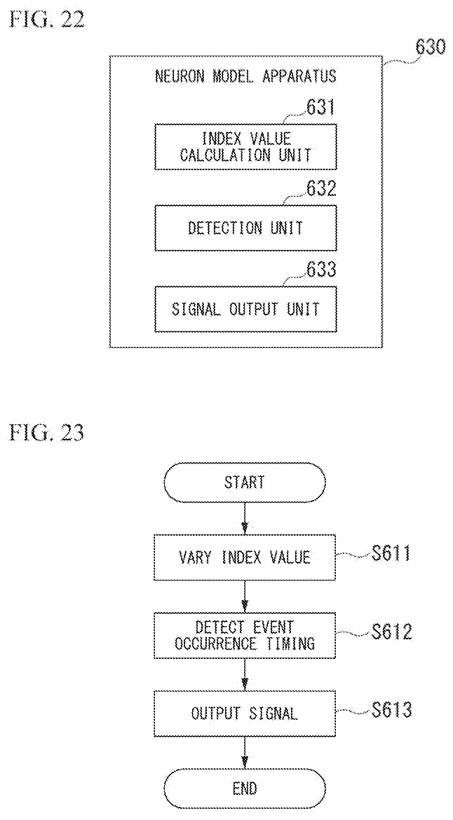

FIG. 22 is a diagram illustrating an example of the structure of a neuron model apparatus according to an example embodiment. With the structure illustrated in FIG. 22, the neuron model apparatus 630 includes an index value calculation unit 631, a detection unit 632 and a signal output unit 633.

With this structure, the index value calculation unit 631, in each time interval, varies the index value of a spike signal output based on the input conditions of a spike signal during that time interval. The detection unit 632 detects the occurrence timing of a prescribed event relating to the index value. The signal output unit 633 outputs a spike signal at a timing that is within a first time interval among the time intervals and that is in accordance with the occurrence timing of the prescribed event in a second time interval that is a time interval further in the past than the first time interval.

By setting the input time intervals during which the neuron model apparatus 630 receives signal inputs and the output time intervals during which the neuron model apparatus 630 outputs spike signals in this way, the time periods during which the index value calculation unit 631 is to calculate index values can be limited to the time periods from when the input time intervals start to when the output time intervals end. During other time periods, the neuron model apparatus 630 can process other data.

According to the neuron model apparatus 630, due to this feature, a spiking neural network can efficiently perform data processing.

Additionally, the neuron model apparatus 630 can adjust the output timings of spike signals in the time intervals by outputting the spike signals in the time intervals following the time intervals in which spike signal inputs were received. According to the neuron model apparatus 630, for example, it is possible to avoid situations in which the spike signal inputs in layers on the downstream side in the data flow in the spiking neural network tend to be concentrated near the ends of the time intervals.

FIG. 23 is a flow chart indicating an example of the processing sequence in a computation method according to an example embodiment. The computation method indicated in FIG. 23 includes varying an index value (step S611), detecting an event occurrence timing (step S612) and outputting a signal (step S612).

When varying the index value (step S611), the index value of a signal output is varied, in each time interval, based on the signal input conditions in that time interval. When detecting the event occurrence timing (step S612), the occurrence timing of a prescribed event relating to the index value is detected. When outputting the signal (step S613), a signal is output at a timing that is within a first time interval among the time intervals and that is in accordance with the occurrence timing of the prescribed event in a second time interval that is a time interval further in the past than the first time interval.

With the computation method indicated in FIG. 23, by receiving spike signal inputs in each time interval and outputting spike signals in the time intervals following the time intervals in which the spike signal inputs were received, the spiking neural network can receive data inputs in each time interval and process each item of data that has been input.

According to the computation method indicated in FIG. 23, due to this feature, a spiking neural network can efficiently perform data processing.

Additionally, with the computation method indicated in FIG. 23, the output timings of spike signals in the time intervals can be adjusted by outputting spike signals in the time intervals following the time intervals in which spike signal inputs were received. According to the computation method indicated in FIG. 23, for example, it is possible to avoid situations in which the spike signal inputs in layers on the downstream side in the data flow in the spiking neural network tend to be concentrated near the ends of the time intervals.

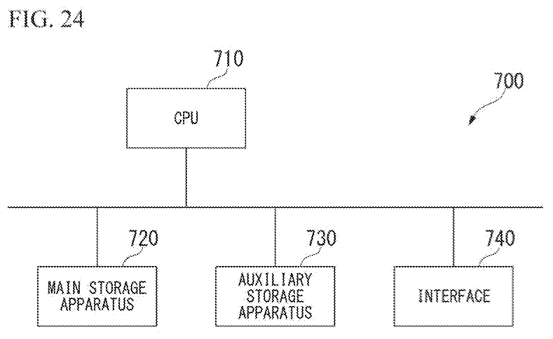

FIG. 24 is a schematic block diagram illustrating the structure of a computer according to at least one example embodiment.

With the structure illustrated in FIG. 24, a computer 700 includes a CPU 710, a main storage apparatus 720, an auxiliary storage apparatus 730, an interface 740 and a non-volatile storage medium 750.

Any one or more or a portion of the above-mentioned neural network apparatus 10, the learning apparatus 50, the computation apparatus 610, the neural network system 620 and the neuron model apparatus 630 may be implemented on the computer 700. In this case, the operations of the respective above-mentioned processing units are stored in the auxiliary storage apparatus 730 in the form of a program. The CPU 710 reads the program from the auxiliary storage apparatus 730 and loads the program in the main storage apparatus 720, then executes the above-mentioned processes in accordance with the program. Additionally, the CPU 710 secures storage areas corresponding to the respective above-mentioned storage units in the main storage apparatus 720 in accordance with the program. Communication between each apparatus and other apparatuses is achieved by the interface 740 having a communication function and communication being performed in accordance with control by the CPU 710.

In the case in which the neural network apparatus 10 is implemented on the computer 700, the operations of the neural network apparatus 10 and the respective units therein are stored in the auxiliary storage apparatus 730 in the form of a program. The CPU 710 reads the program from the auxiliary storage apparatus 730 and loads the program in the main storage apparatus 720, then executes the above-mentioned processes in accordance with said program.

Additionally, the CPU 710 secures storage areas for the processing of the neural network apparatus 10 in the main storage apparatus 720 in accordance with the program. Communication between the neural network apparatus 10 and the other apparatuses is achieved by the interface 740 having a communication function and performing operations in accordance with control by the CPU 710. Interactions between the neural network apparatus 10 and a user are achieved by the interface 740 including a display apparatus and an input device, displaying various images in accordance with control by the CPU 710, and receiving user operations.

In the case in which the learning apparatus 50 is implemented on the computer 700, the operations of the learning apparatus 50 are stored in the auxiliary storage apparatus 730 in the form of a program. The CPU 710 reads the program from the auxiliary storage apparatus 730 and loads the program in the main storage apparatus 720, then executes the above-mentioned processes in accordance with said program.

Additionally, the CPU 710 secures storage areas for the processing of the learning apparatus 50 in the main storage apparatus 720 in accordance with the program. Communication between the learning apparatus 50 and the other apparatuses is achieved by the interface 740 having a communication function and performing operations in accordance with control by the CPU 710. Interactions between the learning apparatus 50 and a user are achieved by the interface 740 including a display apparatus and an input device, displaying various images in accordance with control by the CPU 710, and receiving user operations.

In the case in which the computation apparatus 610 is implemented on the computer 700, the operations of the computation apparatus 610 and the respective units therein are stored in the auxiliary storage apparatus 730 in the form of a program. The CPU 710 reads the program from the auxiliary storage apparatus 730 and loads the program in the main storage apparatus 720, then executes the above-mentioned processes in accordance with said program.

Additionally, the CPU 710 secures storage areas for the processing of the computation apparatus 610 in the main storage apparatus 720 in accordance with the program. Communication between the computation apparatus 610 and the other apparatuses is achieved by the interface 740 having a communication function and performing operations in accordance with control by the CPU 710. Interactions between the computation apparatus 610 and a user are achieved by the interface 740 including a display apparatus and an input device, displaying various images in accordance with control by the CPU 710, and receiving user operations.

In the case in which the neural network system 620 is implemented on the computer 700, the operations of the neural network system 620 and the respective units therein are stored in the auxiliary storage apparatus 730 in the form of a program. The CPU 710 reads the program from the auxiliary storage apparatus 730 and loads the program in the main storage apparatus 720, then executes the above-mentioned processes in accordance with said program.

Additionally, the CPU 710 secures storage areas for the processing of the neural network system 620 in the main storage apparatus 720 in accordance with the program. Communication between the neural network system 620 and the other apparatuses is achieved by the interface 740 having a communication function and performing operations in accordance with control by the CPU 710. Interactions between the neural network system 620 and a user are achieved by the interface 740 including a display apparatus and an input device, displaying various images in accordance with control by the CPU 710, and receiving user operations.

A program for executing all or some of the processing performed by the neural network apparatus 10, the learning apparatus 50, the computation apparatus 610, the neural network system 620 and the neuron model apparatus 630 may be recorded on a computer-readable recording medium, and the program recorded on this recording medium may be read into a computer system and executed to perform the processing of the respective units. The “computer system” mentioned here includes an OS and hardware such as peripheral devices.

Additionally, the “computer-readable recording medium” may refer to a portable medium such as a flexible disk, a magneto-optic disk, a ROM (Read-Only Memory) or a CD-ROM (Compact Disc Read-Only Memory), or to a storage apparatus such as a hard disk that is internal to a computer system. Additionally, the above-mentioned program may be for realizing just some of the aforementioned functions, and furthermore, the aforementioned functions may be realized by being combined with a program that is already recorded in a computer system.

In the foregoing description, the example embodiments of the present disclosure have been explained in detail by referring to the drawings. However, the specific configuration is not limited to these example embodiments and designs or the like within a range not departing from the spirit of this disclosure are also included.

What is claimed is:

1. A computation apparatus that comprises
a spiking neuron model that:
varies, for each of a plurality of time intervals, an index value of a signal output based on an input condition of a signal in the time interval;
detects an occurrence timing of a prescribed event relating to the index value; and
outputs a signal at a timing that is within a first time interval and that is in accordance with the occurrence timing of the prescribed event within a second time interval, the first time interval being included in the plurality of time intervals, the second time interval being included in the plurality of time intervals and being a time interval further in past than the first time interval.

2. The computation apparatus according to claim 1,
wherein the spiking neuron model comprises two timers that determine the timing at which the signal to be output, based on a timing that is a prescribed time period later than the occurrence timing, and
the spiking neuron model switches the two timers for each of the plurality of time intervals.

3. The computation apparatus according to claim 2,
wherein the spiking neuron model comprises:
a first spiking neuron model that varies the index value and detects the occurrence timing of the prescribed event; and
two second spiking neuron models that comprise the two timers, respectively, and output the signal,
when the first spiking neuron model detects the occurrence timing of the prescribed event, the first spiking neuron model outputs the signal to one of the two second spiking neuron models, and
each timer determines the timing at which the signal to be output to be a timing that is within the first time interval and that is based on a timing that is a prescribed time period after a timing at which the signal is received from the first spiking neuron model in the second time interval.

4. A computation method comprising:
varying, for each of a plurality of time intervals, an index value of a signal output based on an input condition of a signal in the time interval;
detecting an occurrence timing of a prescribed event relating to the index value; and
outputting a signal at a timing that is within a first time interval and that is in accordance with the occurrence timing of the prescribed event within a second time interval, the first time interval being included in the plurality of time intervals, the second time interval being included in the plurality of time intervals and being a time interval further in past than the first time interval.

5. A non-transitory recording medium that causes a programmable apparatus to execute:
varying, for each of a plurality of time intervals, an index value of a signal output based on an input condition of a signal in the time interval;
detecting an occurrence timing of a prescribed event relating to the index value; and
outputting a signal at a timing that is within a first time interval and that is in accordance with the occurrence timing of the prescribed event within a second time interval, the first time interval being included in the plurality of time intervals, the second time interval being included in the plurality of time intervals and being a time interval further in past than the first time interval.
